(19) United States
(12) Patent Application Publication
(10) Pub. No.: US 2019/0047480 A1
(43) Pub. Date: Feb. 14, 2019

(54) FOLDING ROOFTOP CONTAINER FOR A MOTOR VEHICLE

(71) Applicant: SES SOLUTIONS GMBH, Freital (DE)

(72) Inventor: Serle Johann Espig, Dresden (DE)

(21) Appl. No.: 16/074,722

(22) PCT Filed: Jan. 31, 2017
(86) PCT No.: PCT/EP2017/052033

§ 371 Date: Aug. 1, 2018

(30) Foreign Application Priority Data
Feb. 1, 2016 (DE) 10 2016 201 476.5
Feb. 10, 2016 (DE) 10 2016 201 993.7
Aug. 15, 2016 (DE) 10 2016 215 171.1

(51) Int. Cl. B60R 9/045; B60R 9/055

(52) U.S. Cl. CPC B60R 9/045; B60R 9/055

(57) ABSTRACT

A foldable roof container for a motor vehicle comprises a bottom element, a cover unit fastened to the bottom element, and an integrated fastening unit for the direct, releasable fastening of the roof container on the motor vehicle.

### CROSS-REFERENCE TO RELATED APPLICATIONS

This is a U.S. national stage entry of International Patent Application No. PCT/EP2017/052033, filed on Jan. 31, 2017, which claims priority to German Patent Application No. 10 2016 201 476.5, filed on Feb. 1, 2016, German Patent Application No. 10 2016 201 993.7, filed on Feb. 10, 2016 and German Patent Application No. 10 2016 215 171.1, filed on Aug. 15, 2016, the entire contents of all of which are fully incorporated herein by reference.

### FIELD OF THE INVENTION

The invention relates to a foldable roof container for a motor vehicle.

### BACKGROUND OF THE INVENTION

U.S. Pat. No. 9,193,306 B2 discloses a foldable roof container, which can be integrated into the roof of a vehicle. A repeated mounting of the roof container is not absolutely necessary.

DE 10 2011 051 891 A1 discloses a removable roof container, which is fastened to a luggage rack on a vehicle roof. The luggage rack is integrated in the bodywork of the vehicle. Structural and design changes to the vehicle itself are required for the fastening of the luggage rack on the vehicle.

### SUMMARY OF THE INVENTION

The problem which the invention proposes to solve is to provide a roof container for a motor vehicle having flexible use and which in particular can be retrofitted on a motor vehicle inexpensively.

The problem is solved by a foldable roof container for a motor vehicle, comprising a bottom element, a cover unit fastened to the bottom element, and an integrated fastening unit for the direct, releasable fastening of the roof container on the motor vehicle. The crux of the invention is that a roof container has a removable design. The roof container comprises an integrated fastening unit, in order to fasten the roof container directly on the motor vehicle, especially the motor vehicle roof. Additional support elements, such as an integrated luggage rack per DE 10 2011 051 891 A1, are unnecessary. As compared to the integrated solution of U.S. Pat. No. 9,193,306 B2, the roof container of the invention involves new ways and possibilities for an uncomplicated retrofitting. The roof container has flexible uses. The roof container may be removed once more at any time. According to the invention, it has been discovered that a reliable fastening of the roof container to the motor vehicle is possible by means of the fastening unit. The fastening unit is integrated in particular in a bottom element of the roof container. Further possibilities have been identified for making use of components present any way on the motor vehicle, such as the motor vehicle roof, as well as shaped elements arranged on the roof, like a roof railing or an antenna molding, for the fastening of the roof container. No alteration of the design of the motor vehicle is needed, especially the bodywork of the motor vehicle, in order to integrate for example the roof container itself or a luggage rack required for this. The roof container of the invention can be retrofitted with no problem on an already existing motor vehicle. The removable roof container can be offered as an accessory for a motor vehicle.

A cover unit is fastened to the bottom element. The cover unit is foldable. In a folded up state of the cover unit, the roof container is flat and in particular sheetlike in design. Sheetlike means that the roof container has a height which is significantly less than the length and the width of the roof container. The height in particular is smaller by an order of magnitude than the length and the width of the roof container. The height in particular amounts to less than 10 cm, especially less than 8 cm, and in particular less than 5 cm. In the folded up state of the cover unit, the height of the roof container is substantially as large as the height of a roof railing of the motor vehicle. In the folded up state of the cover unit, the roof container offers substantially no additional air drag on the motor vehicle. The motor vehicle can be operated economically and ecologically with the roof container in the folded up state. In the unfolded state of the cover unit, the roof container has an inner space which can be stowed with objects such as luggage, particularly bags, suitcases and/or skis. In the unfolded state the roof container is designed as a stowage container. In the unfolded state, the roof container is designed as a three-dimensional holding container.

Surprisingly, it has been discovered that the roof container can be especially advantageously fastened to the already existing structure of the motor vehicle. For this, the roof container may be placed substantially flat with its underside against the motor vehicle roof. A fastening of the roof container on the motor vehicle roof occurs in particular by means of several line or strip shaped fastening elements such as magnetic strips, for example. The magnetic strips are arranged in particular on the underside of the roof container such that they each interact with the cross pillars of the frame of the motor vehicle, especially the A column, the B column and/or the C column. In the region of the longerons of the motor vehicle frame, lengthwise oriented fastening elements may be provided, i.e., in the driving direction, especially magnetic strips. In addition or alternatively, the fastening elements may be arranged in cavities of fastening crimps. Thanks to the linear arrangement of the fastening elements, a framelike fastening structure is created, making possible a reliable fastening line, in particular one which encircles the contour of the underside of the roof container. The fastening is reliable and sturdy. It is conceivable for the bottom element of the roof container to be spaced apart from the motor vehicle roof at least for a section in areas between the fastening lines, i.e., to not lie entirely flat. This is especially the case when the bottom element of the roof container is arranged with a pretensioning, especially a curvature, on the motor vehicle roof.

Alternatively, the fastening unit may enable a large-area and in particular a full-surface adhesion between the bottom element of the roof container and the motor vehicle roof. Surprisingly, it has been discovered that, when the roof container is placed directly on the motor vehicle roof, the entire roof surface of the motor vehicle can be used for the mounting of the fastening unit. As compared to the crossbars known in the prior art, which can be fastened to the railing for example and serve for the pointlike interlocking with a roof container, the available space requirement on the motor vehicle roof is utilized homogeneously and efficiently. The large-area fastening is made possible in particular by the fact that the surface portion of the bottom element of the roof container which is connected to the vehicle roof covers at least 50% of the surface of the motor vehicle roof, especially 70% of the surface of the motor vehicle roof, especially at least 90% of the surface of the motor vehicle roof and especially at least 95% of the surface of the motor vehicle roof. This large-area and in particular full-surface fastening can be realized for example by striplike fastening elements, especially magnetic strips, which are arranged along the outer contour of the bottom element and cover the corresponding surface region of the motor vehicle roof.

A bottom element, which is designed as a single piece and in particular comprises a bottom wall and boundary walls formed on it, especially a front boundary wall, a rear boundary wall and two side boundary walls respectively arranged in between, is sturdy in design. The bottom element is configured in particular as a tray or plate and has a large structural rigidity. Outside boundary walls produce a stiffening of the bottom element. This substantially prevents a bending of the bottom element. The fastening of the bottom element to the motor vehicle roof is improved. The bottom element is made in particular of a lightweight material, especially an aluminum alloy, or a plastic such as acrylonitrile-butadiene-styrene (ABS) and/or polylactide (PLA). The bottom element may also comprise composite materials, especially fiber-reinforced plastics and/or fiber-reinforced composites. The reinforcing fibers are glass fibers or carbon fibers, for example. Such reinforced materials are called glass fiber-reinforced plastics (GFK) or carbon fiber-reinforced plastics (CFK). The reinforcing fibers are typically embedded in a plastic matrix, the plastic matrix comprising epoxy resin in particular. The bottom element may also comprise flexible materials, such as elastomers, particularly rubber and/or chloroprene rubber. In particular, it is conceivable for the bottom element to be made substantially as a single piece of an elastomer and preferably to provide integrated solid structures, especially for the stiffening of the bottom element. A solid structure may be, for example, a frame embedded in the elastomer, an embedded plate or several linear and/or nonlinear rod elements. This solid stiffening structure is made for example of a rigid material such as metal, especially aluminum and/or steel, or a hard plastic, especially a fiber-reinforced plastic. The bottom element in particular may comprise any given combination of the mentioned materials.

A profile element provided in the bottom element enables a stiffening of the bottom element. The bottom element in particular can be mechanically loaded. In particular, at least one profile element is integrated in the bottom element. The profile element is configured as a crimp facing toward the interior of the roof container. The profile element is elevated above a bottom wall of the bottom element. The profile element constitutes an elevation above the bottom wall. The profile element is a formation facing toward the interior of the roof container. The profile element is fashioned as a shaped element. The profile element in particular has a longitudinal extension which is oriented in particular in the longitudinal direction of the bottom element. The longitudinal direction of the profile element is oriented in particular substantially parallel to side boundary walls of the bottom element. In particular, at least one profile element may also serve as a receiving space for the fastening unit. Additional functional elements may be integrated on the at least one profile element, for example being part of the fastening unit and/or serving for anchoring of an object in the roof container and especially on the bottom element. For example, lighting elements may be integrated on and/or in the at least one profile element. A lighting element may be designed for example as an LED-element. LED-elements are available in various configurations. In particular, LED-elements are available in different light colors. In particular, organic light-emitting diodes (OLEDs) exist as thin layer components, which can likewise be lighting elements. The at least one profile element has a multifunctional design and guarantees a good function integration.

A protective coating on an exterior underside of the bottom element ensures that the placing and/or removing of the roof container does not cause any damage to the motor vehicle. In particular, this prevents paint damage being caused to the motor vehicle. The protective coating in particular may be provided on the full surface of the exterior underside of the bottom element.

For the protective function of the protective coating it may be enough to dispose the protective coating at least in part on the underside. The protective coating is in particular a flexible coating. The flexible coating is formed in particular of an elastic material, having in particular a cushioning function. The material is in particular an elastomer, especially rubber.

A magnetic element of the fastening unit, which is integrated in particular in a side boundary wall, in a bottom wall, in a front boundary wall and/or a rear boundary wall, enables a reliable and secure fastening of the roof container directly on the motor vehicle. The magnetic element is in one preferred embodiment a permanent magnet. The magnetic element may also alternatively have the form of a switchable electromagnet. In this way, it is possible to design the magnetic holding force for the fastening of the roof container as a switchable force. In particular, it is possible to deactivate the magnetic holding force for the mounting and dismounting by deactivating the electromagnet. The mounting and dismounting of the roof container is simplified. After placing and aligning the roof container on the motor vehicle, the magnetic holding force of the electromagnet can be activated. This ensures a reliable fastening. In particular, the magnetic element is integrated in the fastening unit and in particular cannot be seen from the outside. The magnetic element enables a reliable fastening on the motor vehicle roof and/or on the roof railing. In particular, several magnetic elements are integrated in the fastening unit. The magnetic elements ensure a planar magnetic holding force between the fastening unit and the motor vehicle roof. The fastening is improved. The magnetic elements may be arranged in particular as a strip, for example along the outer periphery of the bottom element. This makes possible, in particular, a reliable fastening of the roof container on a motor vehicle roof made of a ferromagnetic material, especially highstrength steel. In addition or alternatively it is possible to design the at least one magnetic element as a strip, for example, and to arrange it with a transverse extension on the fastening unit such that the magnetic element extends along a transverse direction of the bottom element. In particular, the magnetic element is oriented transversely and especially perpendicular to side boundary walls of the bottom element. This makes possible a fastening of the roof container to a motor vehicle roof made of non-magnetic material, such as an aluminum alloy or plastic, especially carbon fiber-reinforced plastics. The at least one magnetic element with transverse extension produces a magnetic holding force on the frame element situated beneath the motor vehicle, especially crossbeams. Such frame elements, which are connected for example to the A, B, and/or C column, are typically made of steel materials.

Shaped elements of the fastening unit, which are arranged on the bottom element, especially on the side boundary walls, enable a mechanical fastening of the roof container. The mechanical fastening is not complicated. The shaped elements are arranged on the bottom element, especially on the side boundary walls, and enable a fastening to the roof railing. The shaped elements are in particular elastic, at least for a section. The elasticity of the shaped elements may be produced by a structural elasticity and/or by elastic material properties.

An integration of the shaped elements in the side boundary walls, the shaped elements in particular being designed as a clamping lip situated at an inclination by an angle of inclination with respect to the bottom wall and/or such as to have a profile geometry enclosing a roof railing at least partly or entirely, and/or wherein at least one shaped element in particular is integrated on the bottom wall for at least partial enclosing of an antenna molding situated on the roof, enables a sturdy and noncomplicated design of the shaped elements on the bottom element. In particular, the shaped elements are each designed as clamping lips, which are arranged inclined outward by an angle of inclination with respect to the bottom wall. With the clamping lips, the bottom element can be clamped at the side between the roof railings. The clamping lips, which extend in one preferred embodiment along the entire length or at least for a section on the side boundary walls, have a structural flexibility. The clamping lips make possible a non-positive and/or positive bearing against the roof railing. In addition or alternatively, the shaped elements may have a profile geometry enclosing the roof railing at least partially or entirely. This further increases the holding force by nonpositive and/or positive bearing.

A shaped element integrated on the bottom wall enables the fastening of the roof container on an antenna arranged on the motor vehicle roof. Such an antenna is designed for example as a shark fin and is disposed in particular in roughly the rear third of the roof surface and centrally with respect to a lateral orientation. The shaped element has a form-fit geometry, corresponding to the shape of the antenna, so that an accidental releasing of the roof container in particular even in the event of an abrupt braking and/or an impact of the motor vehicle is substantially prevented on account of the encircling profile geometry of the shaped element, serving as a fastening on the antenna molding.

A hook element of the fastening unit for hooking in a gap of the bodywork of the motor vehicle enables a direct hooking of the roof container in a gap of the bodywork. Such a gap is common, for example, on a top side of the bodywork between the motor vehicle roof and the tailgate. The hook element for example is fashioned as a downward projecting crosspiece, which in particular projects downward at the bottom wall. The crosspiece may also be integrated with the rear boundary wall, protruding downward on the bottom wall. The crosspiece in one preferred embodiment is made of a strong or high-strength material and encased in an elastomer, such as rubber.

A clamping element of the fastening unit, especially a clamping strap, for clamping in a gap of the bodywork of the motor vehicle enables an additional clamping security for the roof container. The clamping element in one preferred embodiment is flexible, in particular as a clamping strap, which can be clamped in an openable gap of the bodywork, especially on a vehicle door and/or at the tailgate. For this, the section being clamped may have an anchor element, the anchor element having a thickness which is greater than the gap width, so that an unintentional pulling of the clamping element out from the gap is precluded.

At least one locking lever of the fastening unit for resting against the roof railing in interlocked manner enables a reliable fastening of the container to the railing, which in some vehicle models has a length less than the length of the roof surface. The locking lever enables an interlocking placement against a front side and/or rear side of the roof railing. A locking lever housing is adapted in particular to the form of the roof railing. The locking lever housing lengthens the shape of the railing on the motor vehicle. The roof container is held reliably particularly in the driving direction.

A protective fastening for protection against accidental releasing of the roof container, wherein the protective fastening can be activated in particular only in the opened state of the roof container, wherein the protective fastening is arranged in particular inside the roof container, prevents an unintentional releasing of the roof container, especially due to an impact of the motor vehicle against an obstacle. The protective fastening ensures that the roof container remains reliably secured to the motor vehicle even during an accident. An unintentional releasing may also occur by unlawful removal. The protective fastening forms an antitheft device. The protective fastening is preferably secured to the bottom element or to a frame of the foldable roof container.

A laterally movable interlocking element of the protective fastening enables a reliable interlocking of the roof container. In particular, it has been discovered that a interlocking element can engage in a lateral recess of a roof railing, so that a removal of the roof container is only possible by releasing the interlocking position of the interlocking element. The interlocking element for example may be a spring-loaded bolt, which locks into an indentation or recess provided for this purpose when placing the roof container on the motor vehicle roof. The interlocking element may also be an activatable interlocking screw, which is screwed into the indentation or recess. The interlocking element is part of an interlock mechanism.

A fastening element of the protective fastening for fastening to a fastening point integrated in the roof, especially one in the form of a fastening screw, enables a direct fastening at a fastening point provided for this purpose, integrated on a motor vehicle roof. In particular, the fastening points are arranged on a top side of the motor vehicle roof. The at least one fastening element can be moved transversely, especially perpendicularly, to the bottom wall, i.e., in the height direction.

A fastening point may also serve for the fastening of the antenna on the motor vehicle roof. At least one or more antenna screws are used for the fastening of the antenna. In particular, it has been discovered that it is possible to loosen the antenna screws, to remove the antenna from the roof of the motor vehicle, and to use the threaded opening integrated in or anchored to the roof of the motor vehicle to screw in the fastening screw. The fastening screw can be screwed into the threaded bore freed up by the removal of the antenna for the fastening of the roof container. Accordingly, a corresponding threaded bore is provided on the roof container, especially on the cover unit and especially on the cover wall, in order to fasten the antenna on the roof container. The antenna fastened on the roof container is connected by a signal cable to the fastening point, wherein the signal cable may be led in particular along the cover element, across a frame hinge and the bottom element to the fastening point and the antenna screw. Basically, it is also conceivable to provide a wireless transmission of the antenna signal from the antenna on the roof container to the fastening point.

A control unit connectable to the motor vehicle for independent driving of the motor vehicle and/or a display element, especially a movable one, for displaying of contents, especially digital contents, enables an advantageous arrangement of artificial intelligence required to operate the motor vehicle for autonomous driving. In particular, retrofittable systems for motor vehicles are known to provide this for autonomous driving. Such retrofit systems for autonomous driving are typically arranged on the motor vehicle roof in the front area. It is conceivable to arrange these systems in spacesaving manner in the roof container. The control unit in particular can be placed in signal communication with the motor vehicle, especially an onboard computer of the motor vehicle. The signal communication may be by cable or wireless. No additional space requirement is needed in the motor vehicle and/or on the motor vehicle roof for the artificial intelligence of the control unit and/or the retrofit system. With the roof container, additional functionalities, especially autonomous driving of the motor vehicle, can be retrofitted without complication, for example by updating the onboard computer of the motor vehicle with appropriate software interacting with the artificial intelligence.

A display element enables a flexible displaying of images and/or lettering such as “taxi” or “police”. In particular, the display element enables the displaying of digital contents, especially in the form of a monitor screen, especially in the form of a movable monitor screen. In particular, the display element is arranged on the roof container, especially in a front area facing toward the windshield of the motor vehicle or in a rear area, facing toward the rear of the motor vehicle. The display element may be arranged at the side, i.e., on side walls of the roof container, or also on a rear wall. It is also conceivable to provide several display elements, especially on both sides on the side walls of the roof container. With the aid of the display element, digital content can be displayed in changeable manner. The display element serves as a flexible lettering, for example in the form of a running text strip and/or as a changeable display, i.e., with changeable content, for the roof container and especially for the motor vehicle.

Another problem of the invention is to improve the security of objects during transport in a roof container.

The problem is solved by a foldable roof container for a motor vehicle, comprising a bottom element, a cover unit fastened to the bottom element, at least one integrated anchoring unit for the anchoring of an object in the roof container, wherein the anchoring unit comprises in particular an anchoring element at which the object is releasably anchorable to a corresponding mating anchoring element. By means of at least one anchoring unit, an object can be anchored in the roof container. Driving movements, especially abrupt acceleration and braking and/or steering maneuvers of the motor vehicle are not a problem. The object is arranged in definite and reliable manner in the roof container. The roof container comprises a bottom element and a cover unit secured to it, which in particular has a fold-open design. The anchoring unit is integrated in particular on the bottom element. The anchoring unit comprises in particular an anchoring element, which interacts with a mating anchoring element of the object being secured in a releasable and anchorable manner.

Further advantageous embodiments, additional features and details of the invention will emerge from the following description of sample embodiments with the aid of the drawing.

### BRIEF DESCRIPTION OF THE DRAWING

FIG. 1 shows a perspective exploded view of a roof container according to the invention,

FIG. 2 shows a top view of a bottom element of the roof container per FIG. 1,

FIG. 3 shows a perspective, partly sectional, enlarged detail representation from the rear of the roof container per FIG. 2,

FIG. 4 shows a longitudinal section corresponding to FIG. 3,

FIG. 5 shows a perspective schematic representation of a motor vehicle roof with a roof railing,

FIG. 6 shows a cross sectional representation along sectioning line IVIV in FIG. 5,

FIG. 7 shows a cross sectional representation corresponding to FIG. 6 of a fastening unit with a lateral shaped element,

FIG. 8 shows a perspective view from above of a motor vehicle roof with a bottom element according to another embodiment,

FIG. 9 shows an enlarged cross sectional representation of a side fastening of the bottom element per FIG. 8,

FIG. 10 shows a schematic cross sectional representation of a fastening by means of a hook element along sectioning line X-X in FIG. 8,

FIG. 11 shows a perspective cutout view of a motor vehicle with the roof container with unfolded cover unit and clamping elements,

FIG. 12 shows a perspective representation of a motor vehicle with a roof container according to another embodiment,

FIG. 13 shows an enlarged detail representation of the fastening unit per FIG. 12 in an activated or opened state,

FIG. 14 shows a perspective representation of a motor vehicle roof with fastening points,

FIG. 15 shows a perspective view of a bottom element for a roof container according to another embodiment,

FIG. 16 shows a top view corresponding to FIG. 15,

FIG. 17 shows an enlarged, perspective detail representation of a protective fastening,

FIG. 18 shows a schematic representation of the roof container per FIG. 15 in an interlocked arrangement of the protective fastening on the roof railing,

FIG. 19 shows a perspective enlarged representation of another protective fastening,

FIG. 20 shows a schematic representation of a radio-controlled activation of a lock of a roof container,

FIG. 21 shows an enlarged detail representation of an antenna fastened on the roof of the motor vehicle,

FIG. 22 shows a representation corresponding to FIG. 21 with the antenna released from the motor vehicle roof,

FIG. 23 shows a cross sectional representation with a roof container fastened at the fastening point per FIG. 22,

FIG. 24 shows a representation corresponding to FIG. 23 with the antenna fastened on the roof container per FIG. 22,

FIG. 25 shows a longitudinal section of the antenna fastened on the roof container per FIG. 24,

FIG. 26 shows an antenna of a motor vehicle according to another embodiment,

FIG. 27 shows a representation of the antenna released from a holder per FIG. 26,

FIG. 28 shows a representation corresponding to FIG. 23 of the fastening of the roof container in a fastening point designated therefor per FIG. 27,

FIG. 29 shows a perspective view of the bottom element of the roof container per FIG. 1 with an object fastened to it,

FIG. 30 shows an enlarged, perspective cross sectional representation through a roof container in the folded up state,

FIG. 31 shows a perspective representation corresponding to FIG. 2 of a bottom element according to another embodiment,

FIG. 32 shows an enlarged perspective representation of a profile element with a suction cup mounting,

FIG. 33 shows a longitudinal section along sectioning line XXXIII-XXXIII in FIG. 32,

FIG. 34 shows a schematic cross sectional view of a roof container according to another embodiment with a load sensor,

FIG. 35 shows a perspective representation of the unfolded roof container in opened arrangement according to another embodiment,

FIG. 36 shows a perspective representation of the frame of the roof container per FIG. 35,

FIG. 37 shows an enlarged detail representation of detail XXXVII in

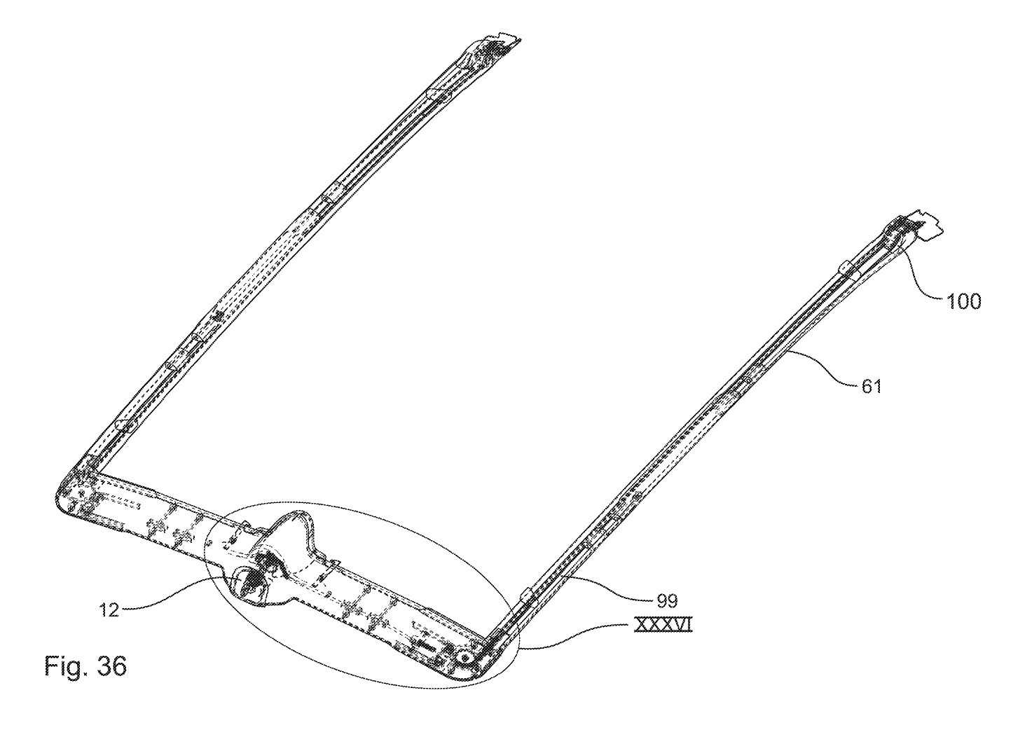

FIG. 36,

FIG. 38 shows an enlarged perspective detail representation of a roof container in which the fastening unit has at least one locking lever, and

FIG. 39 shows an arrangement corresponding to FIG. 38 with the locking lever in the pivoted interlocked state.

### DESCRIPTION OF THE PREFERRED EMBODIMENTS

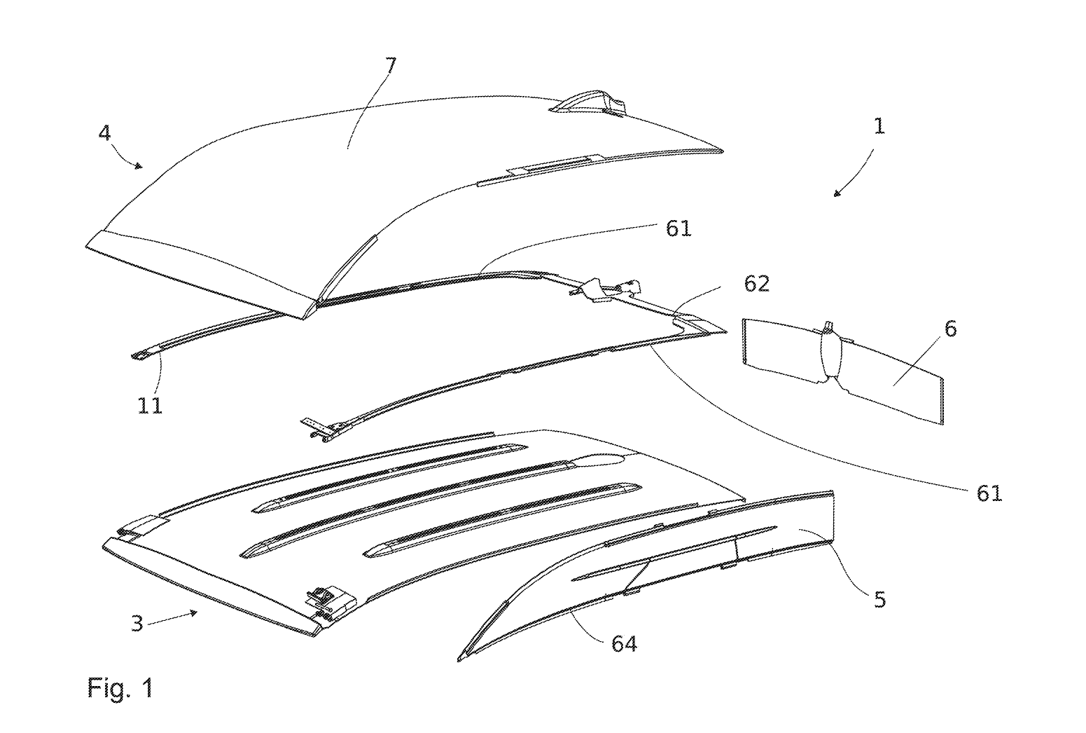

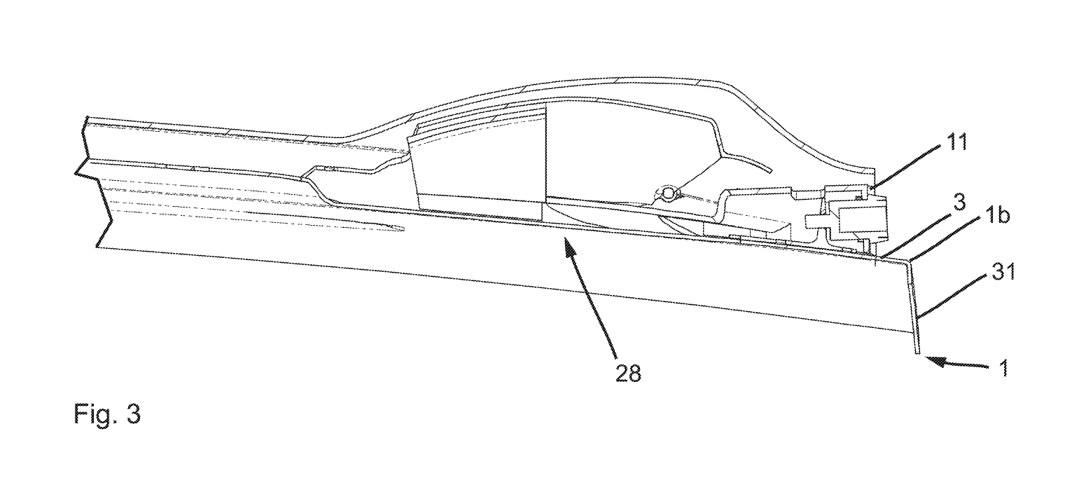

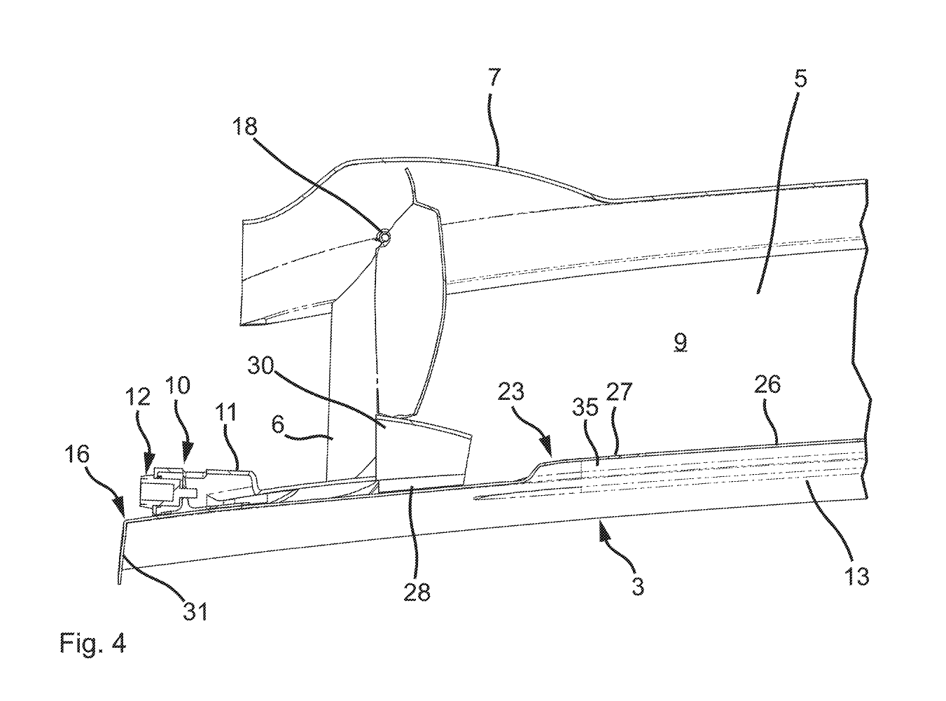

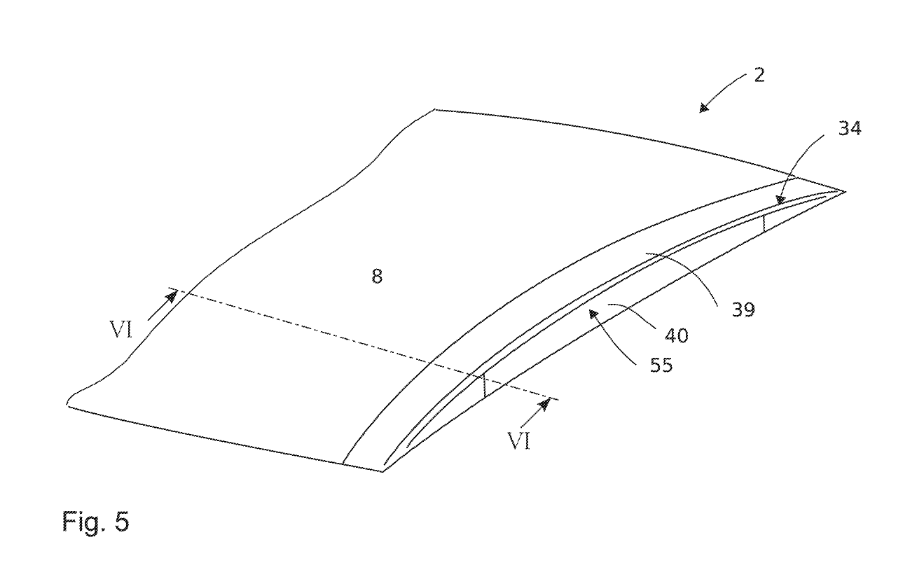

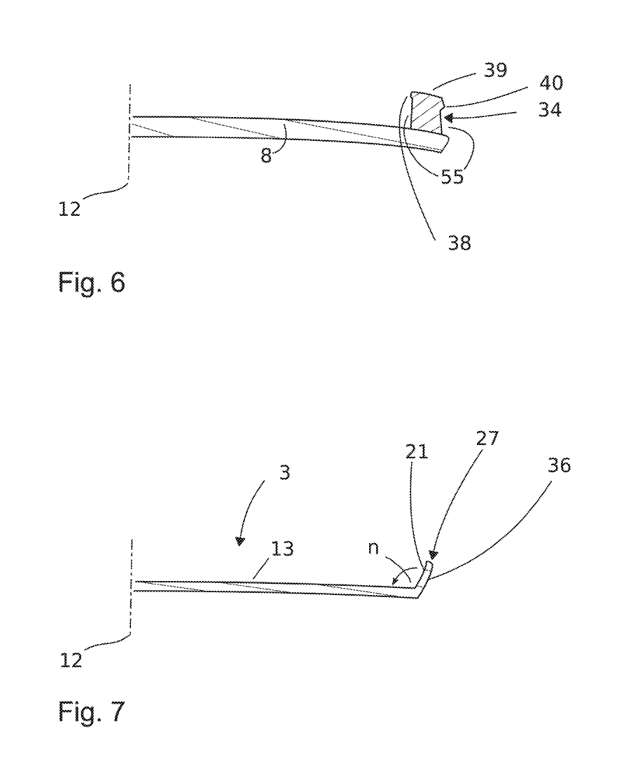

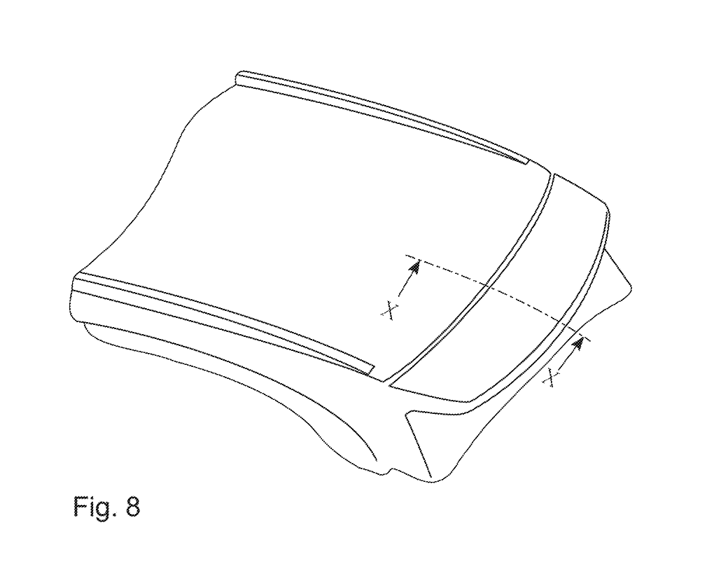

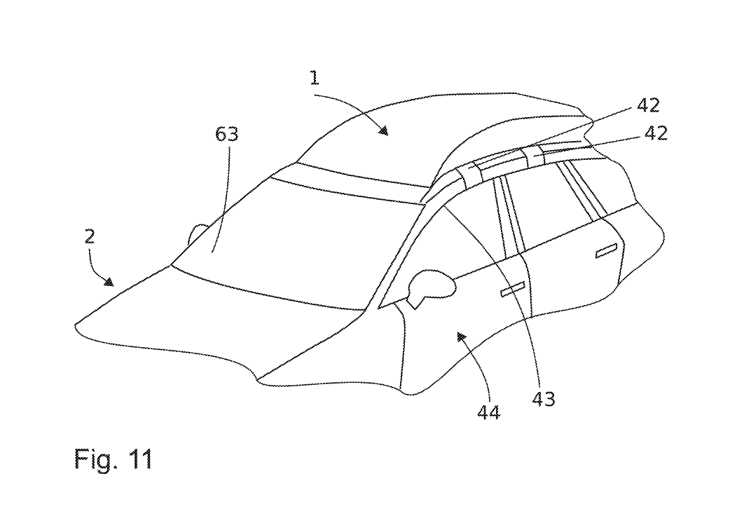

A roof container 1 for a motor vehicle 2 as represented in FIGS. 1 to 11 comprises a bottom element 3 and a cover unit 4 fastened to it. The cover unit 4 is fastened by a frame 11 to the bottom element 3. The frame 11 is substantially U-shaped and has two lateral longitudinal elements 61, which are oriented substantially parallel to each other and are joined together as a single piece by means of a rear element 62 at a rear side.

The cover unit 4 comprises foldable side walls 5, only one side wall 5 being shown in FIG. 1 for reasons of presentation. The side walls 5 are respectively hinged to the bottom element 3 and able to swivel about their lower edge 64. The cover unit 4 moreover has a rear wall 6 and a cover wall 7. The frame 11 connects the side walls 5, the rear wall 6 and the cover wall 7. The elements 5, 6, 7 and 11 so connected form the cover unit 4. The rear wall 6 is pivot-hinged to the bottom element 3. The cover wall 7 is pivotably connected to the side walls 5 and the rear wall 6.

The foldable cover unit 4 can be folded between a folded-up arrangement and an unfolded arrangement. In the folded-up arrangement, the roof container 1 is configured flat. The roof container 1 may be stowed in spacesaving manner and with little additional air drag on a roof 8 of the motor vehicle 2. In the unfolded state, the side walls 5, the rear wall 6, the cover wall 7 and the bottom element 3 enclose an inner space 9. Objects can be transported in the inner space 9.

The size of the bottom element 3, i.e., the base surface of the roof container 1, is substantially dictated by the size of the roof 8 of the motor vehicle 2. The volume of the inner space 9 of the roof container 1 may be between 100 l and 500 l for a motor vehicle, especially a passenger car. For a commercial vehicle, such as a small transporter, which has a larger roof surface than a passenger car, the volume of the inner space 9 of the roof container 1 may be significantly larger and amount, for example, to 700 l and especially 1000 l or more.

The roof container 1 moreover has a lock unit 10. In the unfolded state of the cover unit 4, the lock unit 10 is arranged outside the inner space 9. The lock unit 10 is integrated in a frame 11, in which a lock 12 is integrated. The lock 12 makes it possible to lock the roof container 1 and to prevent in particular an unintended and/or unauthorized use or access to the inner space 9 of the roof container 1.

Details of a foldable roof container with an unfoldable cover unit as well as details regarding the unfolding and folding up of such a roof container are described in DE 10 2011 051 891 A1 and in U.S. Pat. No. 9,193,306 B2, to which reference is hereby explicitly made. A significant difference from these already known roof containers is that the cover wall 7 of the roof container 1 is a single piece. The cover wall 7 is also called the cover element.

In the following, the bottom element 3 in particular will be explained more closely. The bottom element 3 may be fashioned substantially as a tray. The bottom element 3 is made as a single piece.

The bottom element 3 has a bottom wall 13. The shape of the bottom wall 13 is adapted to the contour of the roof 8 of the motor vehicle 2. The bottom wall 13 may have a curvature. The bottom wall 13 is substantially flat. The bottom wall 13 is substantially rectangular and has two side lengthwise edges 14, a front edge 15 and a rear edge 16. The front edge 15 is turned toward the windshield 63 of the motor vehicle 2 and is curved according to the contour of the windshield 63 and/or the contour of the roof 8 of the motor vehicle 2. The lengthwise edges 14 are arranged opposite each other at the bottom wall. The lengthwise edges 14 are arranged facing a roof railing 34. The rear edge 16 is arranged facing the rear of the vehicle, especially a tailgate 33. The bottom element 3 and in particular the bottom wall 13 have a longitudinal axis 17. The bottom element 3 is configured symmetrical to the longitudinal axis 17. The side walls 5 of the cover unit 4 are each hinged pivotably on the bottom element 3 in the region of the lengthwise edge 14. The rear wall 6 of the cover unit 4 is hinged to the cover wall 7 and can swivel about a pivot axis 18. The cover wall 7 is hinged to the bottom element 3 and can swivel in the region of the front edge 15. Swivel bolts 22 are provided for the pivot-hinging of the cover wall 7 to the bottom element 3, being arranged in the front area of the bottom wall 13, adjacent to the front edge 15.

In the area of the rear edge 16, the bottom wall 13 has a hook element 31 formed as a single piece on it. The hook element 31 is designed as a web oriented downward along the rear edge 16, i.e., facing toward the car roof 8. The hook element 31 is part of the fastening unit and serves for engaging in a gap 32 of the motor vehicle 2. The gap 32 is situated in particular between the roof 8 and a tailgate 33 of the vehicle 2. The hook element 31 prevents an unintentional sliding forward of the roof container 1 in event of full braking and/or an impact of the motor vehicle 2 against an obstacle. The hook element 31 makes possible a direct positive locking of the roof container on the motor vehicle 2. In particular, it has been discovered that the gap 32 present anyway on the motor vehicle 2 can be utilized for the positive-locking fastening of the roof container 1.

Arranged as a single piece on the bottom wall 13 are a front boundary wall 19, a rear boundary wall 20 as well as two side boundary walls 21. The boundary walls 19, 20, 21 are joined together in particular and form an encircling side boundary web around the bottom wall 13.

In the bottom wall 13 according to the sample embodiment shown there are formed three profile elements 23. The profile elements 23 are each oriented parallel to the longitudinal axis 17. The profile elements 23 are longitudinal profile elements. The profile elements 23 have a longitudinal extension, which is oriented parallel to the longitudinal axis 17. In a sectioning plane perpendicular to the longitudinal axis 17, the profile elements have a substantially trapezoidal contour, which is facing toward the inner space 9. The profile elements 23 are eminences extending from the bottom wall 13 in the direction of the inner space 9.

In the longitudinal direction the profile elements 23 have respectively an outlet region 24 at a front end facing toward the front edge 15 and at a rear end facing toward the rear edge 16. In a main region 25 of the profile element 23 arranged between the outlet regions 24, several oblong holes 26 and through-openings 27 are provided on a horizontal wall along the longitudinal extension, in particular, arranged in alternation.

The profile elements 23 form an integrated anchoring unit. The anchoring unit serves for the anchoring of an object, such as a suitcase or skis, in the roof container 1. Unintentional and especially critical steering, acceleration and/or braking maneuvers do not result in an unwanted shifting of the objects in the roof container 1. Both the roof container 1 and the objects are thus better protected. The anchoring unit comprises substantially anchoring elements which are formed by the oblong holes 26 and/or the through-bores 27. Accordingly, corresponding mating anchoring elements can be provided on the objects, which may be designed for a latching or engaging or screwing.

The oblong holes 26 have a substantially constant oblong hole width, having at one point, especially in the middle along the longitudinal axis 17, a central bore 60 with a diameter which is larger than the width of the oblong hole. At the central bore 60, for example, a mating interlocking element of an object can be introduced into the slot of the oblong hole 26. The mating interlocking element may be for example a spring-loaded stud, whose head has a diameter which is smaller than the diameter of the central bore 60, but larger than the width of the slot of the oblong hole 26. By lengthwise shifting of the object with introduced stud along the oblong hole, the object with the mating interlocking element is securely fastened to the profile element 23. In order to prevent and in particular rule out an unwanted shifting along the oblong hole 26, the head on the mating interlocking element may be spring-loaded, so that a spring force produces a pressing of the head from the cavity 35 against the underside of the profile element 23. Several central bores 60 may also be provided at the oblong hole 26, being in particular spaced apart evenly at the oblong hole 26. The distances between two adjacent central bores 60 of an oblong hole 26 may also be different in size.

The bottom wall 13 moreover has an antenna shaped element 28. The antenna shaped element 28 is devised as a through-opening in the bottom wall 13. The through-opening is arranged concentrically to the longitudinal axis 17 and adjacent to the rear edge 16. The antenna shaped element 28 in the sample embodiment shown in FIG. 1 is located beneath the outlet region 24 of the centrally arranged profile element 23. The antenna 30 of the motor vehicle 2 can be led through the antenna shaped element 28.

On the underside facing the roof 8, the bottom wall 13 has a protective layer or protective lining. This ensures that the paint is not scratched or ruined when placing the roof container 1 on the roof 8 or removing it. The protective layer and/or the protective lining may occupy the shape of the antenna in the region of the antenna of the motor vehicle 2 and extend in particular over the antenna as a shaped element 28, so that the antenna 30 is also protected against scratching.

A fastening unit is integrated in the bottom element 3. The fastening unit serves for the direct fastening of the roof container 1 or its bottom element 3 on the roof 8 of the motor vehicle 2. By means of the fastening unit, the roof container 1 may be mounted releasably on the roof 8. The roof container 1 has a removable design. Additional fastening elements, such as supporting elements in the form of luggage racks, can be omitted. The roof container 1 is mounted and secured directly on the motor vehicle roof 8.

The fastening unit according to the sample embodiment shown has several integrated magnetic elements 29. The magnetic elements 29 in particular are strip-shaped and embedded in the bottom wall 13 of the bottom element 3. According to the sample embodiment shown, the magnetic elements 29 are arranged along the lengthwise edges 14 and the front edge 15. It is also conceivable to provide additional magnetic elements along the rear edge 16. The number and shape of the magnetic elements may be adapted according to an intended magnetic holding force. In particular, it is conceivable to provide additional or alternative magnetic elements 29. In particular, it is conceivable for several magnetic elements 29 to be oriented transversely and in particular perpendicular to the longitudinal axis 17. It is advantageous when the magnetic elements 29 enable, besides the direct fastening on the roof 8 of the motor vehicle 2, also a fastening to frame elements situated beneath the roof 8, especially support columns of the motor vehicle frame.

The magnetic elements 29 may also be integrated in the vertically oriented side boundary walls 21. In this way, it is possible to fasten the bottom element 3 with additional magnetic holding force on a roof railing 34. The magnetic elements 29 may additionally or alternatively be arranged in a cavity 35 formed by the profile element 23 facing away from the inner space 9.

According to the sample embodiment shown, the fastening unit has further shaped elements, which are arranged on the side boundary walls 21. The shaped elements are designed such that they enclose an angle of inclination n with the bottom wall 13 of the bottom element 3 which is greater than 90°. The shaped elements of the side boundary walls 21 are arranged tilted outward with respect to the bottom wall 13, i.e., facing away from the inner space 9. The outwardly tilted shaped elements at the side boundary walls 21 are designed as clamping lips 36. It is possible, as shown in FIG. 7, for the side boundary wall 21 as a whole to form the clamping lip 36. Alternatively, it is possible for a clamping lip to be pivoted as a section or region on the side boundary wall. In this case, the side boundary wall 21 could be oriented substantially vertically with a clamping lip extending from it at an inclination.

It is important that the clamping lip 36 rests by its free end, i.e., by an outer clamping lip edge 37, clamping against a corresponding protrusion 38 of the roof railing 34. The protrusion 38 is situated at an upper end of a side indentation 55. The side indentation 55 is bounded in the height direction by the roof 8 and the protrusion 38. The side indentation 55 in particular is also provided on an outer side of the roof railing 34 facing away from the roof container 1. The roof railing 34 has a multiply curved cross section, substantially T-shaped in one preferred embodiment, in a plane perpendicular to the longitudinal axis 17. On a top side facing away from the motor vehicle roof 8, the roof railing 34 has an upper web 39, which sticks out at both sides from a vertical web 40. Because the width of the vertical web 40 is smaller than the width of the upper web 38, indentations 55 are provided at the roof railing 34 on both sides, the indentations 55 extending only for a portion along the longitudinal axis 17 and in particular not having the same length as the upper web 39. In particular in the end regions, where the height of the roof railing 34 is reduced to a minimum value, the vertical web 40 has substantially the identical width as the upper web 39. In this region, no indentations are disposed. The indentations of the roof railing 34 are axially bounded.

It is also important that the clamping lip 36 is suitable to embrace a substantially free-standing web of a roof railing, which is connected to the roof 8 in particular only in the front and rear region of the motor vehicle 2. No vertical web 40 is provided for such a roof railing 34. The indentations 55 are not blind holes, but rather through-openings in a transverse direction of the motor vehicle 2.

The clamping lip 36 is structurally elastic. This means that the material thickness of the clamping lip 36 is so thin that an elastic bending of the clamping lip 36 toward the bottom wall 13 is possible. In particular, the elastic bending is made possible substantially regardless of the material of which the clamping lip 36 is made. In this way, it is possible to place the roof container 1 by the bottom element 3 from above onto the motor vehicle 2. An outer spacing of the two clamping edges 37 of the oppositely situated clamping lips 36 is greater than an inner spacing which is dictated by the facing inner edges of the upper webs 39 of the roof railing 34. By putting the roof container 1 in place by the bottom element 3, it is locked onto the motor vehicle roof and interlocks by the clamping lips 36 in the side indentations 55 of the roof railing 34, since the clamping lip edges 37 rest against the protrusions 38 of the indentations 55.

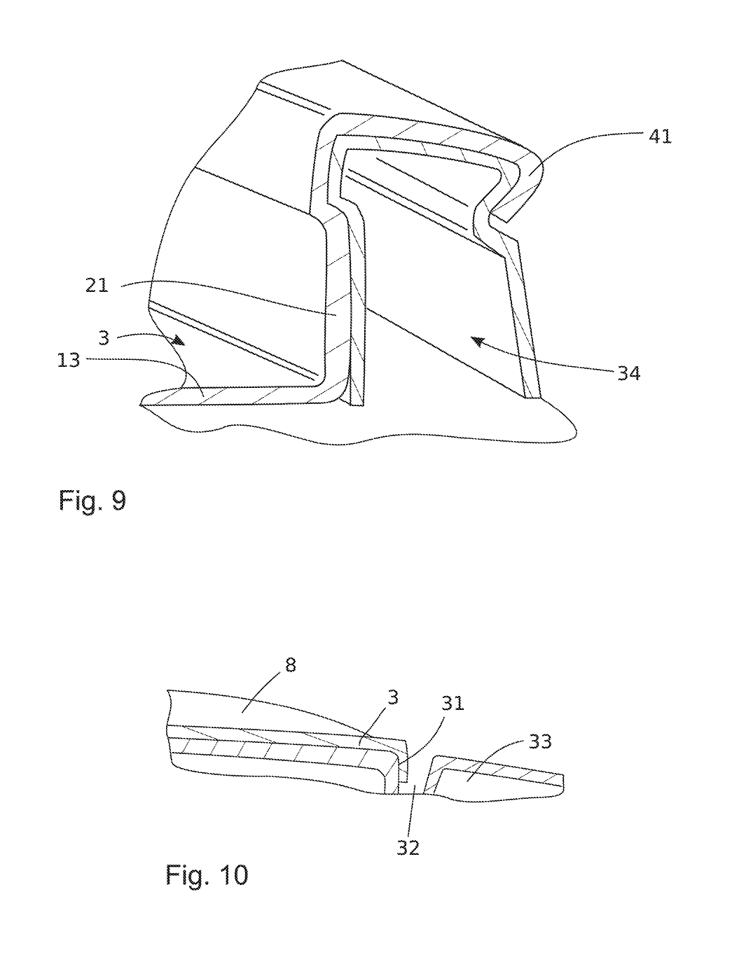

In an alternative embodiment per FIG. 9, the shaped elements which are formed integrally on the side boundary walls 21 may have a profile geometry 41 corresponding to the roof railing 34. This improves a holding force of the roof container 1 on the motor vehicle roof 8. The bottom wall 13 is advantageously secured to the motor vehicle roof and produces an aesthetically pleasing overall picture. The roof container mounted on the roof 8, together with the roof 8, produces a uniform appearance. The mounted, removable roof container 1 is not perceived as being an additional element.

The fastening unit may have further clamping elements 42, as shown in FIG. 11. The clamping elements 42 are designed in particular as a clamping strap each time. The clamping strap is secured by a first end on the roof container 1, especially on the bottom element 3, and especially on the bottom wall 13.

The clamping element 42 is led out from the roof container 1 via a slotlike opening, for example, which can be integrated in particular in the side boundary wall 21. A second end of the clamping element 42, situated opposite the first end, comprises an anchor element, not shown, having an increased thickness as compared to the clamping element 42. The anchor element in particular is fashioned as a thickening of the clamping strap. The clamping element 42 may be clamped in a door gap 43 of the car door 44 and/or tailgate. The clamping element 42 in particular is a flexible band.

Similar to a seat belt, the clamping element 42 may be designed as a belt passing transversely and/or lengthwise through the inner space 9 of the roof container 1 and/or through the bottom element 3 of the roof container 1. The clamping element 42 in particular is designed in accordance with a modern vehicle belt. For example, an automatic tightening up of the clamping element 42 may occur depending on the driving speed of the motor vehicle. In addition or alternatively, a clamping element lock may be provided in which the clamping element may be locked, similar to a belt lock. In the locked arrangement of the clamping element in the clamping element lock, a release signal may be generated from the clamping element lock and transmitted in particular to an onboard computer of the motor vehicle 2, especially wirelessly. For example, it is conceivable to outfit the dashboard of the motor vehicle with an additional signal display for the reliable locking of the clamping element. The belt may be used for example for luggage securing, especially for skies 79, as is represented in FIG. 29. A ski 79 is held by means of the clamping element 42 in the form of a clamping belt on the bottom element 3. The clamping element 42 is led through the oblong holes 26 of the profile elements 23 to an underside of the bottom element 3 or into the cavity 35 formed by the profile elements 23. The belt locks may be arranged in the cavity. Several clamping elements 42 may be arranged along the oblong holes 26 or along the profile elements 23 for the securing of the skis 79.

In addition, sensors may be arranged in the bottom element 3, which detect whether an object is arranged in the roof container 1 or on the bottom element 3. Such sensors are used for example in the vehicle seat to detect a person on the seat. If an object is arranged in the roof container, but not anchored by means of the holding element 42, a warning signal can be sent to the driver in the motor vehicle, asking the driver to secure the cargo. The sensors in particular are integrated in the bottom element 3.

The belt may be clamped in the clamping gaps 32, 43 and thus be anchored. In particular, the band is water repellent. In particular, four clamping elements 42 are provided on the roof container 1, two each on the side boundary walls 21.

The roof container 1, especially the bottom element 3 and in particular the bottom wall 13, have a protective fastening 48 in the form of fastening screws, not shown, which are inserted through fastening openings 49 and serve for direct screwing at fastening points 50 per FIG. 14 on a motor vehicle roof 8. Such fastening points 50 are provided in particular in motor vehicles 2 not having any roof railing. Such fastening points 50 are integrated in the motor vehicle roof 8. The fastening points 50 in particular have a receiving screw thread, in which the fastening screws can be screwed. The fastening openings 49 in particular are accessible only when the roof container 1 is opened, and thus not closed. The protective fastening 48 provides an antitheft protection.

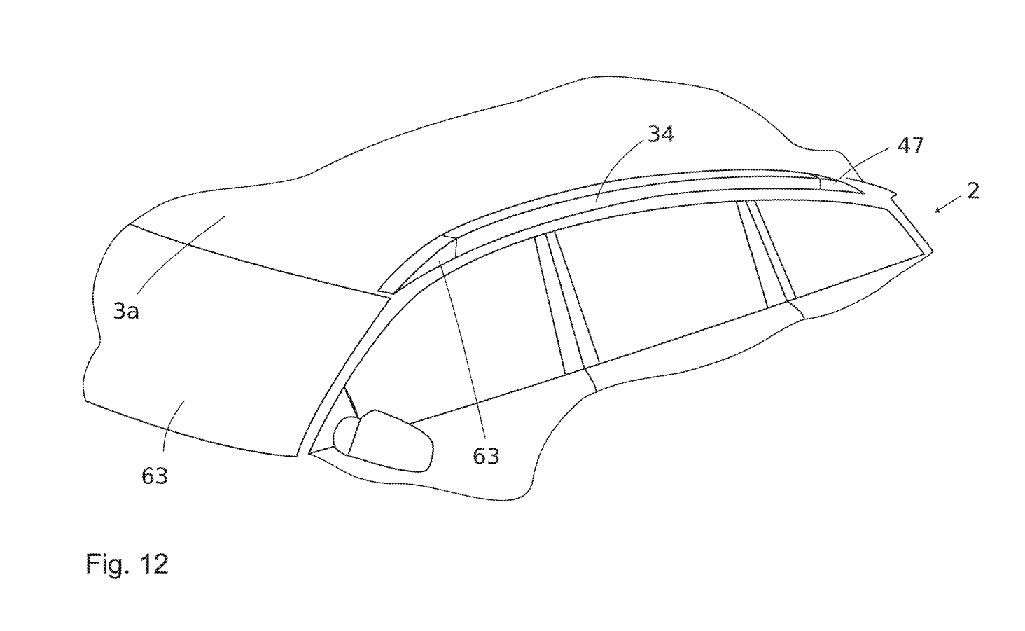

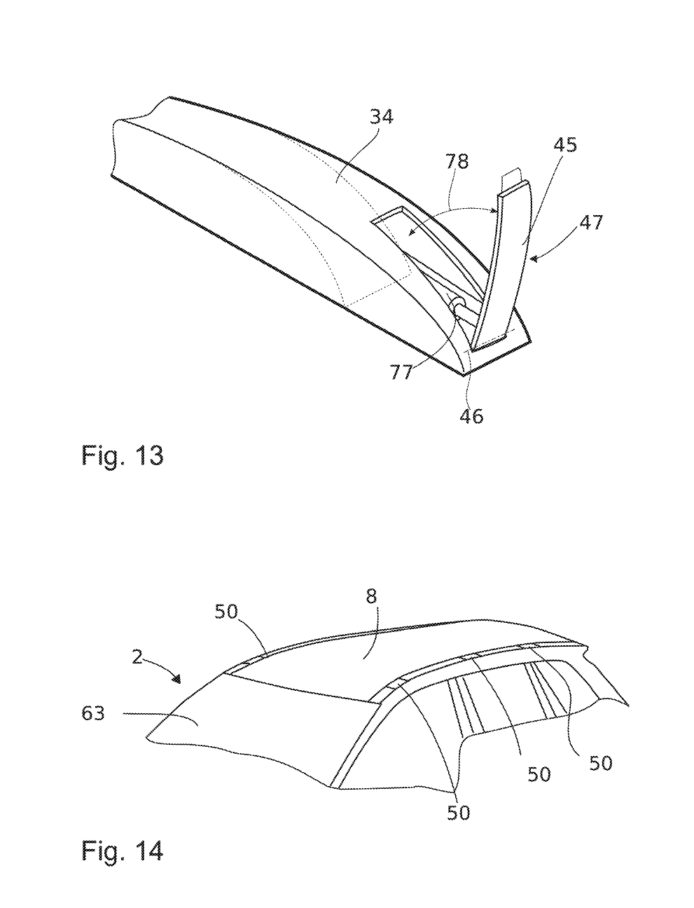

In the following, another sample embodiment of the invention will be described with reference to FIGS. 12 and 13. Structurally identical parts will be given the same reference numbers as in the first sample embodiment, to whose description reference is hereby made. However, structurally different, yet functionally identical parts will be given the same reference numbers with an added “a”.

The major difference of the roof container 1a is that the bottom element 3a has a front region and a rear region, in which the bottom element 3a extends substantially across the entire width of the roof 8 of the motor vehicle 2. In particular, the width of the bottom element 3a perpendicular to the longitudinal axis 17 is greater than a spacing of the roof railing 34 of the motor vehicle 2. In this way, it is possible to open up additional stowage space for the roof container 1a, since the roof container 1a can extend over the entire roof surface, especially the entire length of the roof 3.

In order to additionally fasten this roof container 1a, especially the bottom element 3a, the fastening unit may have several locking levers 45. The locking lever 45 is arranged in a locking lever housing 47, able to swivel about a pivot axis 46 along a swivel direction 78. The locking lever housing 47 is substantially wedge-shaped and adapted to the form of the roof railing 34 present on the motor vehicle 2. In an interlocked position, the locking lever 45 is situated in or on the locking lever housing 47. The locking lever 45 is interlocked by latching elements with the interlocking element housing 47 and/or the roof railing 34. In the interlocked arrangement of the locking lever 45, the roof container 1a is additionally secured to the roof railing 34, especially along a driving direction.

An actuator 77 is provided for the swiveling movement of the locking lever 45 about the pivot axis 46. In the sample embodiment shown, the actuator 77 is represented as a piston/cylinder unit, especially in the form of a pneumatic cylinder. The pneumatic cylinder 77 can be extended by means of a drive unit, i.e., automatically. It is also conceivable for the actuator 77 to be spring-loaded and to be released, when the locking lever 45 is manually activated, from an interlocked arrangement per FIG. 12 and to move by virtue of the prestressed spring into the deployed position in FIG. 13. For this, the actuator 77 is linked by a free end directly to the locking lever 45. The linkage point is at a distance from the pivot axis 46, in order to enable a torque on the locking lever 45 about the pivot axis 46. The piston/cylinder unit may also be designed as a hydraulic cylinder. Alternative drive units, such as a spindle drive, are also conceivable.

The locking lever 54 may also be designed as a locking screw or latching element with a rotary closure, in order to ensure the interlocking position in or on the locking lever housing 47.

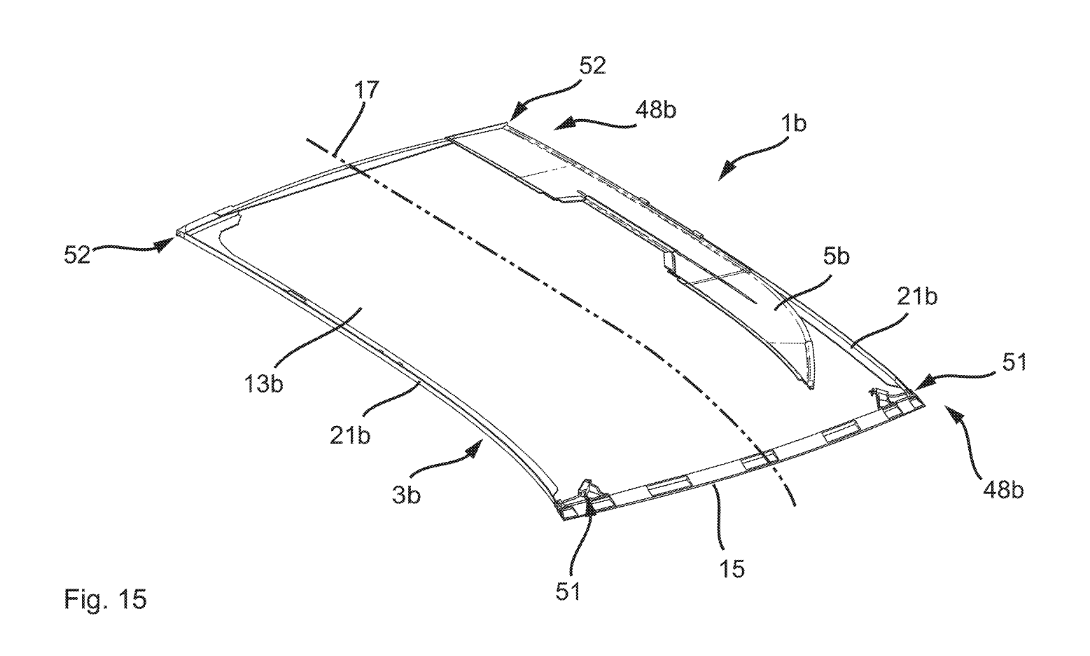

In the following, another sample embodiment of the invention will be described with reference to FIGS. 15 to 19. Structurally identical parts will be given the same reference numbers as in the previous sample embodiments, to whose description reference is hereby made. However, structurally different, yet functionally identical parts will be given the same reference numbers with an added “b”.

The major difference from the previous sample embodiments is that in the roof container 1b the protective fastening 48b has additional interlocking elements 51, 52. The interlocking elements 51, 52 are arranged in each case on the side boundary walls 21. The interlocking elements 51, 52 can move sideways, i.e., transversely and especially perpendicular to the longitudinal axis 17.

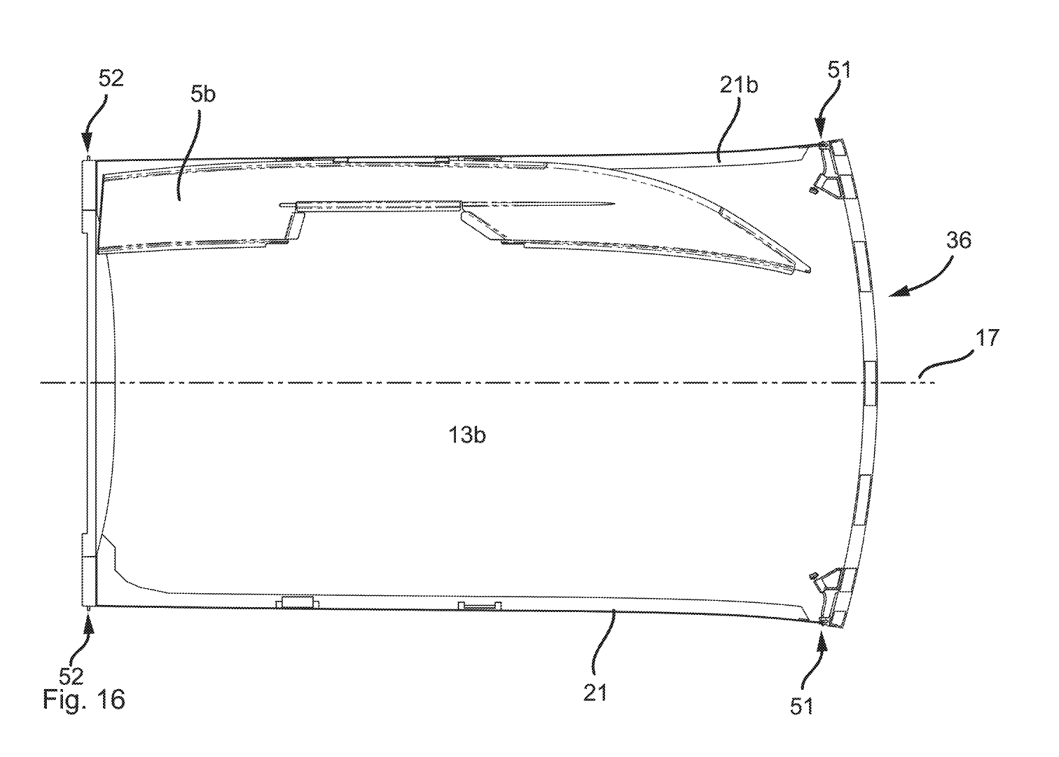

The space-saving arrangement of the roof container 1b in the folded-up state becomes especially apparent from the top view of FIG. 16. In the folded-up state, the side walls are in a substantially horizontal arrangement. The side elements are folded onto the bottom element. The side elements lie substantially flat on the bottom element. This likewise holds for the rear wall 6 and the cover wall 7 and the frame 11.

In the folded-up state, the mentioned elements lie one on top of another, i.e., they are arranged in layers. Basically no space is provided between the foldable elements of the roof container 1.

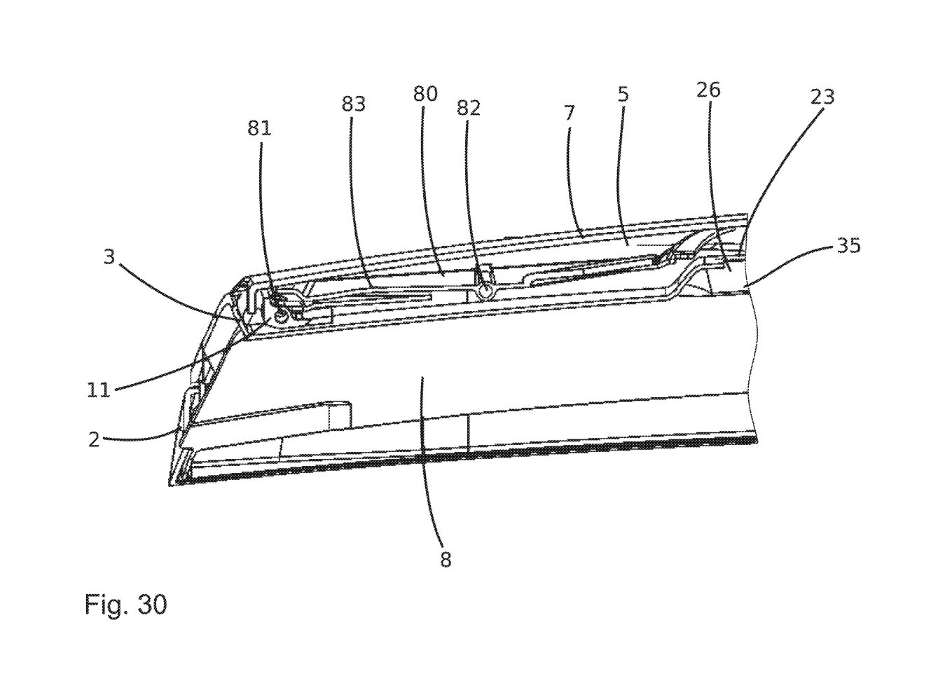

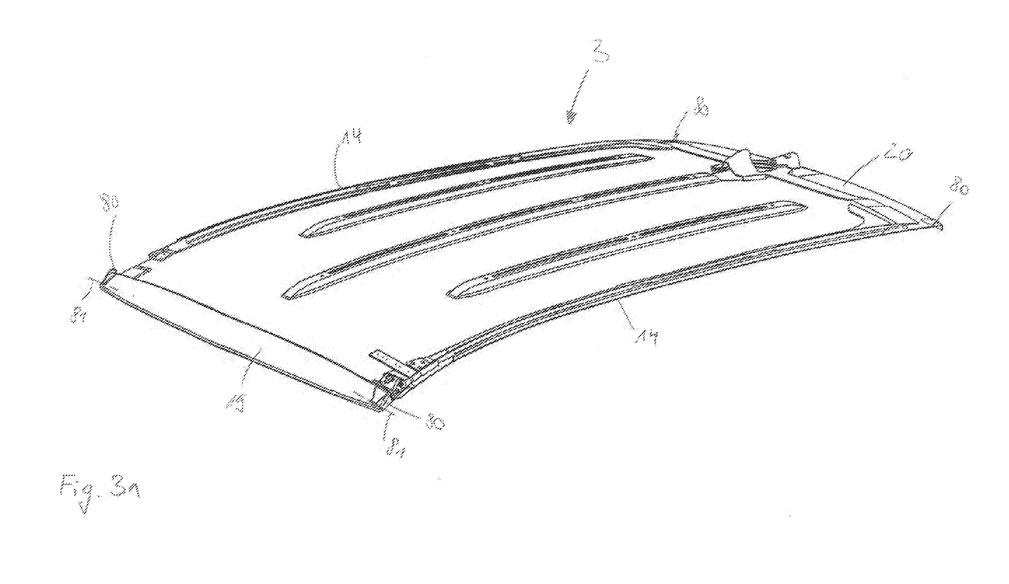

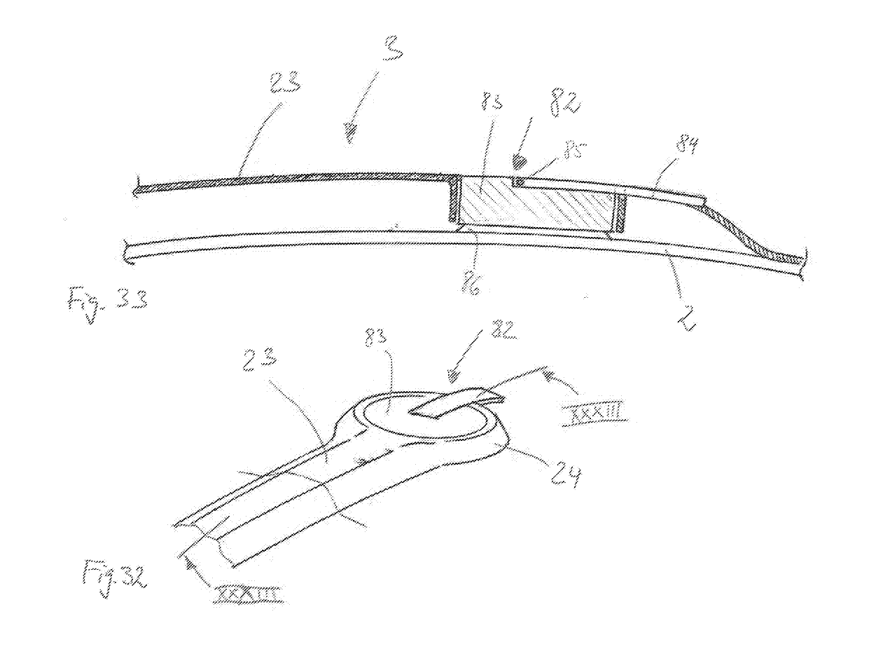

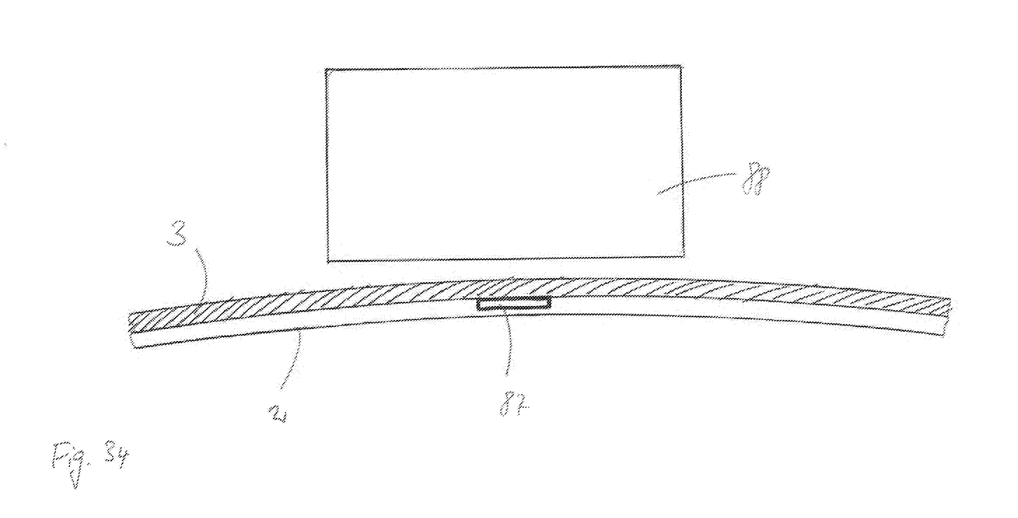

FIG. 30 shows a cross sectional representation of the roof container 1 in a folded-up arrangement. In the folded state, a small foldable side wall element 80, being part of the side wall 5, is folded together in several layers. The side wall element 80 has a first hinge 81 and a second hinge 82, each with a hinge axis. With the first hinge 81, the side wall element 80 is pivotably hinged on the frame 11. The second hinge 82 connects the first hinge 81 to another wall element 83, which is connected to the side wall 5. In the folded-up arrangement of FIG. 30, the two hinges 81, 82 are arranged substantially on a horizontal plane.

By folding open, the first hinge 81 pivots counterclockwise, as in FIG. 30.

The second hinge 82 is pivoted clockwise. In the unfolded arrangement, the hinges 81, 82 are disposed with their respective hinge axes substantially in a vertical plane, so that the second hinge 82 is situated substantially vertically above the first hinge 81.

The hinges 81, 82 each have a tubular cavity, in which additional functions could be integrated, such as a latching mechanism for the side wall element 80 and/or an elevating mechanism, especially a drive unit for the cover wall 7.

The hinges 81, 82 can also be designed differently, especially in the form of a film hinge.

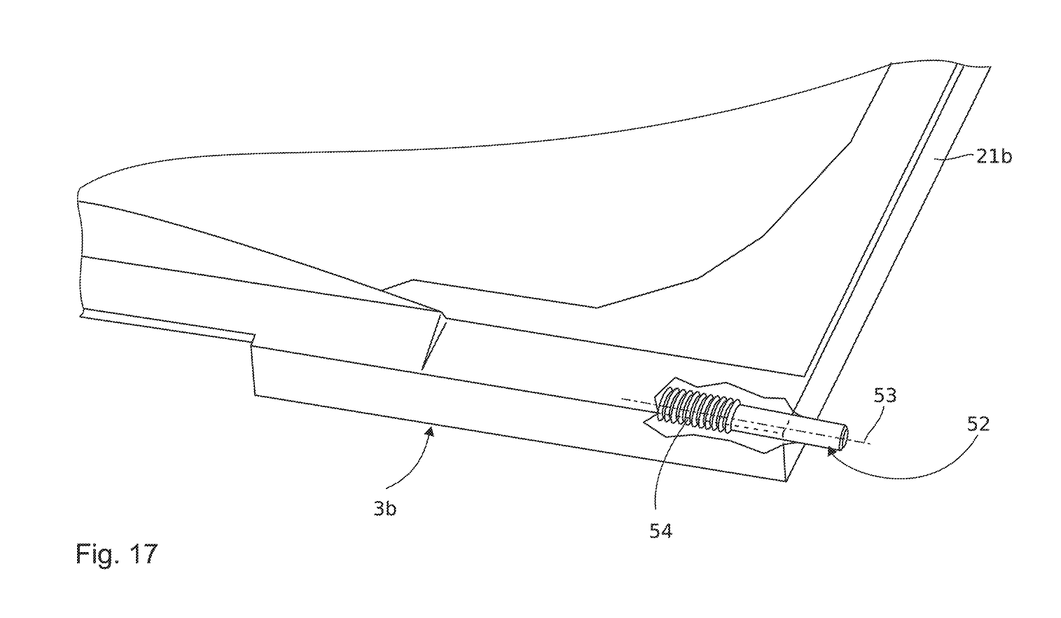

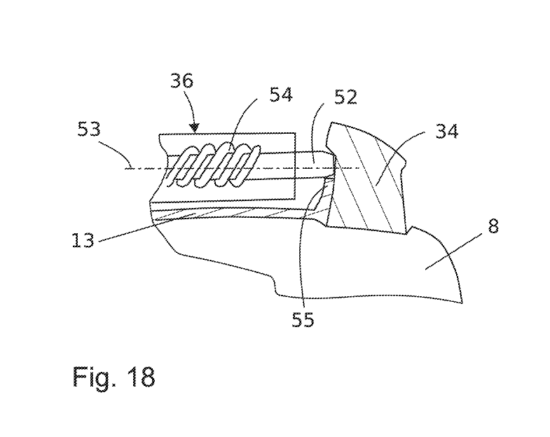

In the following, the construction and function of the interlocking element 52 shall be explained more closely with the aid of FIGS. 17 and 18. The interlocking element 52 is designed as a spring-loaded interlocking bolt. The interlocking bolt can move along an interlocking axis 53, which is oriented transversely and especially perpendicular to the longitudinal axis 17. The interlocking bolt is spring-loaded by means of a spring element 54, which is integrated in the bottom element 3b. In an unloaded arrangement, the spring tensioning of the spring element 54 means that the interlocking bolt is forced out from the recess on the bottom element 3b provided for it. The interlocking bolt 52 in the nonactivated arrangement extends beyond the side boundary wall 21b.

For the fastening of the roof container 1b on the roof 8, the bottom element 3b is placed from above onto the roof 8. The interlocking bolt of the interlocking element 52 extends at the side beyond the side boundary wall 21b such that it rests in particular against the upper web 39 of the roof railing 34. Thanks to the contact with the roof railing 34, the interlocking bolt is pressed against the spring force along the interlocking axis 53 into the bottom element 3b.

When the roof container 1b is bearing with the bottom element 3b on the roof 8 of the motor vehicle 2, as shown in FIG. 18, the interlocking bolt is forced outward by the spring force, into the side indentation 55 of the roof railing 34. In this arrangement, the roof container 1b is interlocked with the bottom element 3b reliably on the roof 8 and especially on the roof railing 34.

An unlocking of the interlocking bolt is not easily possible. For example, an unlocking is conceivable, for example by means of an unlocking lever, not illustrated, situated in the inner space 9 of the roof container 1b, such that the interlocking bolt is pulled back into the bore provided for it along the interlocking axis 53. When the interlocking element 52 is situated with the interlocking bolt outside the side indentation 55, the roof container 1b with the bottom element 3b can be removed from the roof of the motor vehicle 2.

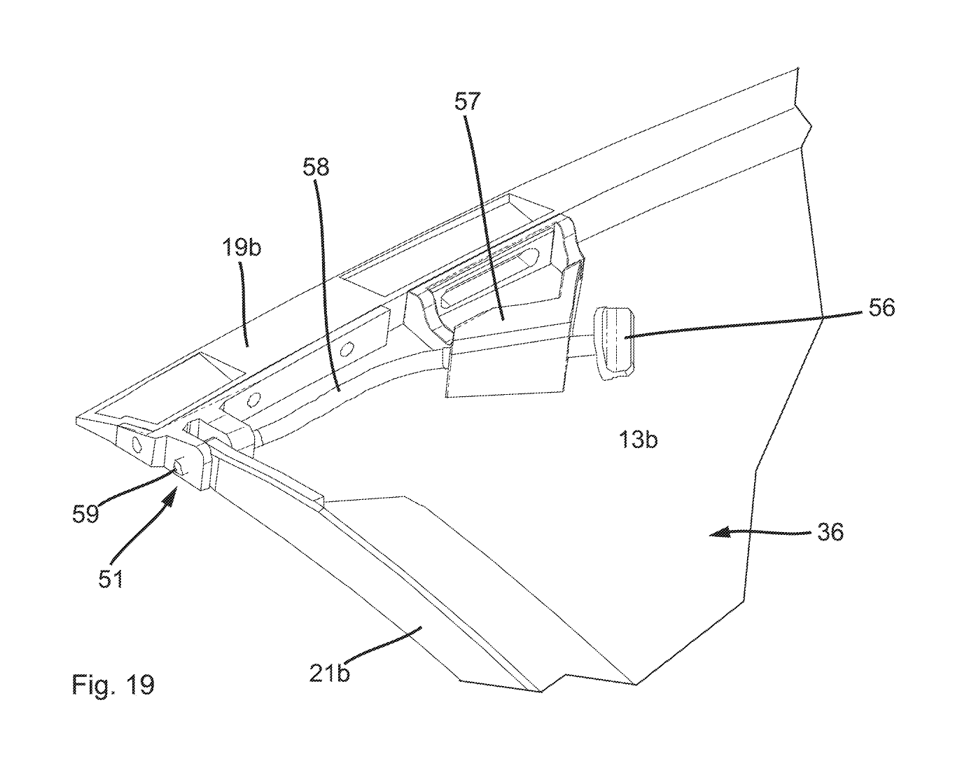

In the following, the construction and function of the interlocking element 51 shall be explained more closely with the aid of FIG. 19. The interlocking element 51 has an activating element 56 in the form of a knob. The activating element 56 is received in a support assembly 57. In the support assembly 57 there is arranged a spindle drive, having a flexible spindle 58. The flexible spindle 58 is led out from the support assembly 57 and has an interlocking bolt 59 at an end situated opposite the support assembly 57.

The activating element 56 with the support assembly 57 is arranged in the inner space 9 of the roof container 1b. In the sample embodiment shown, the support assembly 57 is a single piece with the front boundary wall 19b. The support assembly 57 is situated at a distance from the front boundary wall 19b. The flexible spindle 58 is arranged along a curved path, so that the interlocking bolt 59 can be situated adjacent to the front boundary wall 19b. One longitudinal distance, i.e., a distance along the longitudinal axis 17 from the interlocking bolt 59 to the front boundary wall 19b, is less than a longitudinal distance from the support assembly 57 to the front boundary wall 19b.

By an activating of the activating element 56, i.e., by turning the knob, the spindle drive is activated and the flexible spindle 58 is extended. Accordingly, the interlocking bolt 59 is moved outward in a direction transversely and especially perpendicularly to the longitudinal axis 17 with respect to the side boundary wall 21b. The interlocking bolt 59, similar to the interlocking bolt of the interlocking element 52, can engage in the side indentation 55 of the roof railing 34. By contrast with the interlocking element 52, the interlocking bolt 59 is moved continuously to the side by the activation of the activating element 56. The interlocking bolt 59 is substantially an interlocking screw, which is screwed against the roof railing 34. The interlocking screw in particular secures a pivot axis of a hinge, which connects the bottom element 3 and the cover unit 4. At the hinge, the cover unit 4 is linked to the frame 11 and is pivotably hinged on the bottom element 3. The hinge axis corresponds to the interlocking axis 53. The interlocking axis 53 is situated in the front region of the bottom wall 13. By swiveling the cover unit 4 to and from the bottom element 3 about the interlocking axis 53, the roof container 1 can be opened and closed.

Alternatively, it is conceivable to provide side interlocking openings on the roof railing 34, in which the interlocking bolt 59 or the interlocking bolt of the interlocking element 52 can engage.

The interlocking elements 51, 52 serve for the antitheft protection. The protective fastenings in particular are arranged on the interior, i.e., in the inner space 9, of the roof container 1b and are only accessible when the roof container 1b is opened.

Alternatively, a Bowden cable system can also be provided for the unlocking of the interlocking element 52, not being represented in FIGS. 15 to 19. Such a Bowden cable system could be connected, for example, to a lock unit, also not shown, in order to be able to make possible an unlocking of the roof container 1b for example by activating the lock, i.e., by opening the roof container 1b. An explicit key position may be provided for this in the lock.

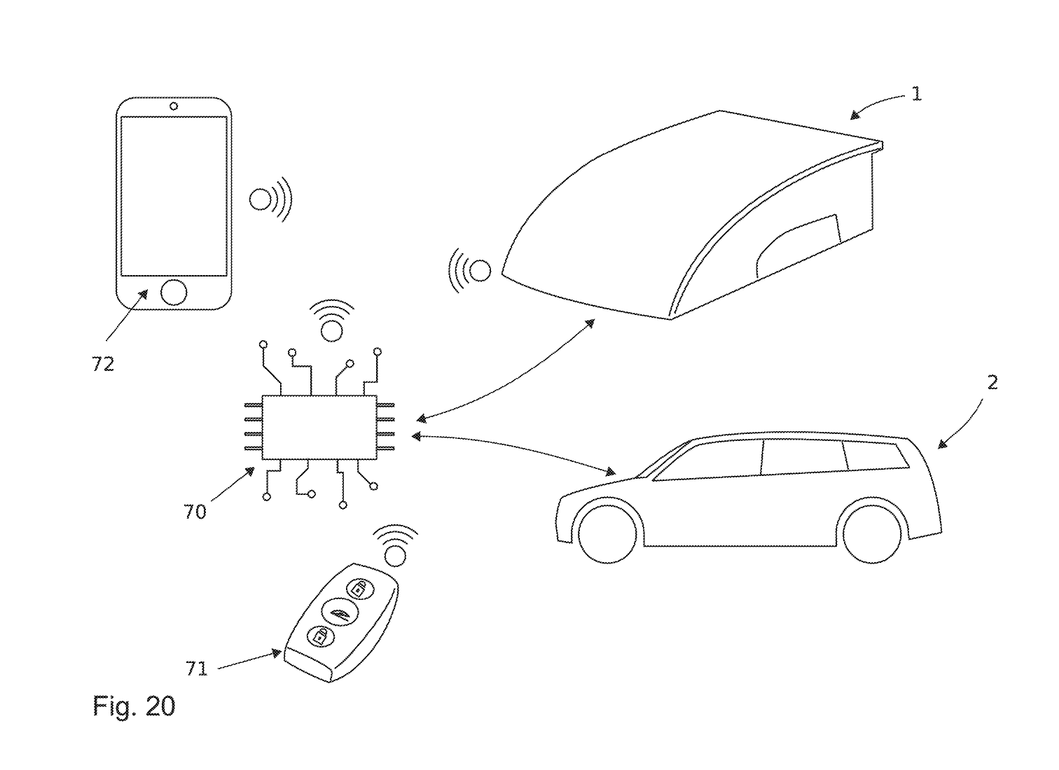

According to another alternative shown in FIG. 20, it is possible to control the unlocking of the interlocking element remotely. For this, a receiver module 70 is provided, which is integrated in particular in the roof container 1. The receiver module 70 is suited to receiving wireless signals. A wireless signal may be sent for example from a radio key 71 or a mobile terminal device 72, such as a smartphone and/or a tablet computer.

The receiver module 70 is in signal communication in particular with a drive unit for the automatic opening, i.e., unfolding of the roof container 1. This signal communication with the drive unit of the roof container 1 may by cable and/or wireless. It is also conceivable for the receiver module 70 to be integrated in the motor vehicle 2. In particular, a receiver module 70 can be used in the motor vehicle 2 which is already in communication with a radio key 71. Thus, an activation of the lock is possible by means of an opening element, which may be designed in particular as the radio key 71 or mobile terminal device 72. The receiver module 70 required for this may advantageously be integrated in the onboard computer of the motor vehicle 2 or be in communication with it.

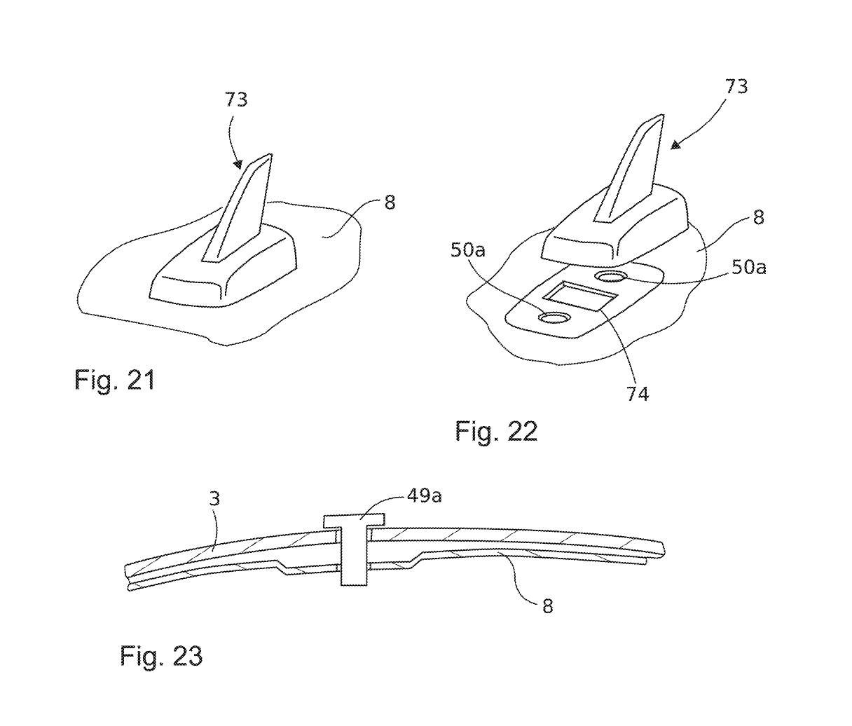

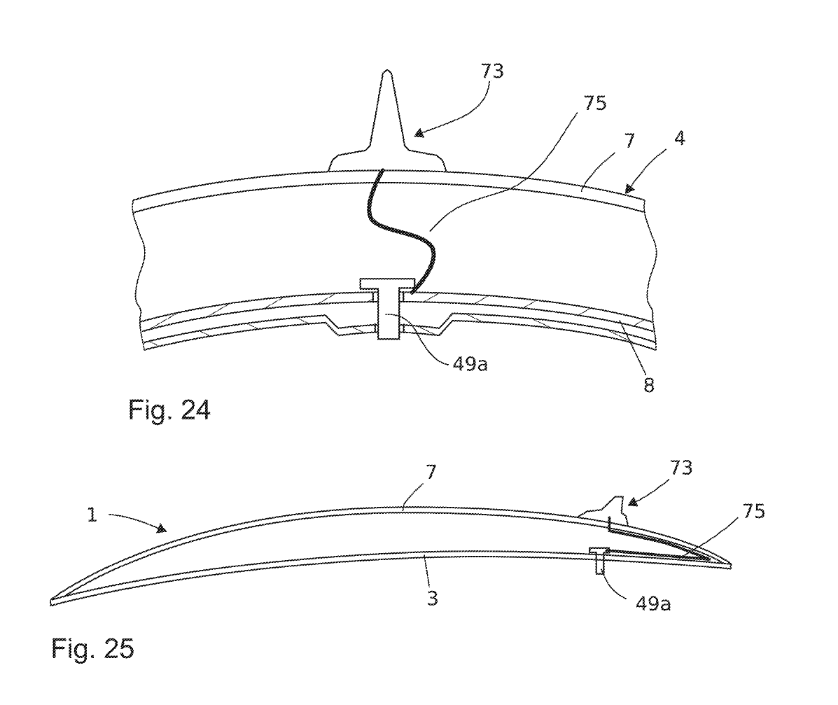

In addition or alternatively to the fastening points 50 per FIG. 14, further fastening points 50a may be provided on the motor vehicle roof 2. In the sample embodiment shown in FIGS. 21 to 25, the motor vehicle antenna 73 is screwed onto the motor vehicle roof 8. The fastening points 50a shown in FIG. 23 serve for this, being configured as threaded bores. The threaded bores each have an opening with internal thread, into which antenna screws, not shown, can be screwed. According to FIG. 23, a through-opening is provided on the motor vehicle roof 8 between the fastening points 50a. The through-opening 74 serves for example to lead cables from the antenna to the motor vehicle 2, for example for the signal transmission.

It has been discovered that it may be advantageous to utilize the fastening points 50a of the antenna 73 for the fastening of the roof container 1. For this, the antenna screws, not shown, are loosened and the antenna 73 is removed from the motor vehicle roof 8. The fastening points 50a now lie free. A fastening screw in the form of a fastening element 49a can be screwed into the fastening points 50a in order to fasten the roof container 1 with a bottom element 3 on the motor vehicle roof.

In order to ensure the functionality of the antenna 73, it is connected by a signal cable 75 directly to the fastening screw 49a. In order to ensure a substantially undisturbed use of the inner space of the roof container 1, the signal cable 75 is led on an inner side of the cover unit 4, especially the cover wall 7, into the rear region of the roof container 1 and along the bottom element 3 from the corner region to the fastening screw 49a.

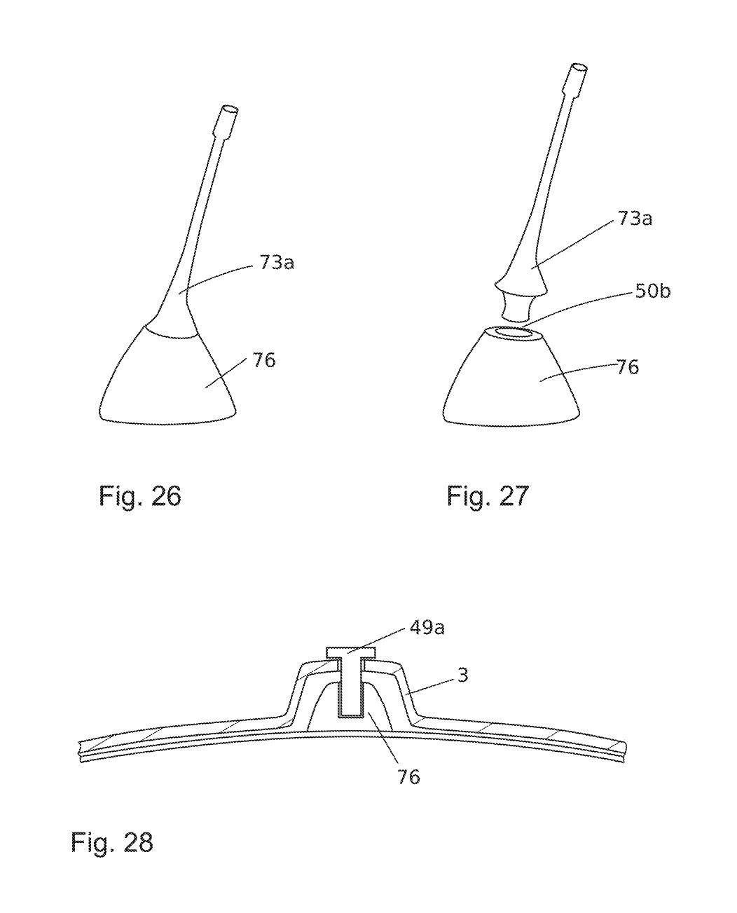

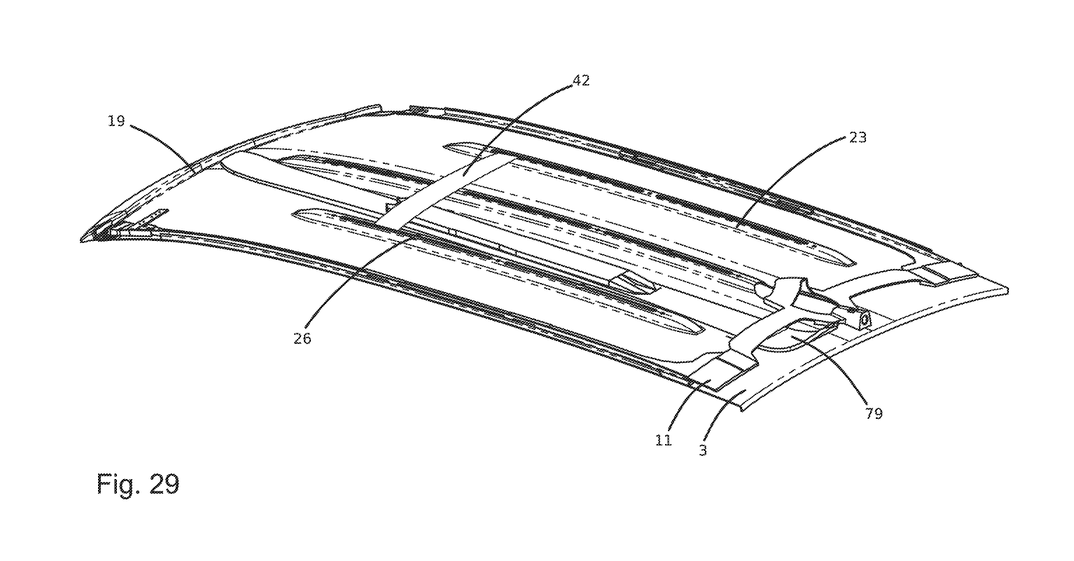

The fastening of the roof container 1 at an antenna 73a occurs in similar fashion according to another embodiment shown in FIGS. 26 to 28. The major difference from the antenna 73 is that the antenna screw is an integrated part of the removable antenna 73a.

The fastening point 50b is designed as a threaded bore. The threaded bore is formed at a top side of an antenna base 76. The antenna base is a pedestallike elevation on the roof 8 of the motor vehicle. Accordingly, it is necessary for the bottom element 3 of the roof container 1 to have a recess corresponding to the antenna base 76. In the region of this recess, a throughopening is provided, through which the fastening screw 49a can be used for the fastening of the bottom element 3 at the fastening point 50b.

It is possible to use the roof container for the storage of power and/or for the power supply of electronic consumers. For example, solar cells can be arranged on a top side of the roof container, especially on a top side of the cover unit, especially on a top side of the cover element, in order to generate an electric current. This electric current may be stored for example by means of an energy storage unit, especially a storage cell. The energy storage unit may for example be integrated in the front boundary wall 19 in space-saving manner, as is shown in FIG. 29. The energy storage unit may be integrated in the roof container. It is also conceivable to use a storage cell which is present already in the motor vehicle. For this purpose, an energy transmission interface is provided between the roof container and the motor vehicle. The energy interface is configured in particular by inductive transmission.

In particular, the roof container is designed so as to be energy-neutral in operation with respect of the motor vehicle. Energy-neutral means that all the electrical energy which is supplied for possible energy consumers of the roof container, such as the display element, the lock, the automated folding and unfolding of the roof container, especially the drive units needed for this, and/or the control unit for autonomous driving, is supplied by means of the electrical energy which is generated by the solar cells and/or intermediately stored in the storage unit. The electronic consumers in particular are directly connected to the solar cells and/or to the storage unit.

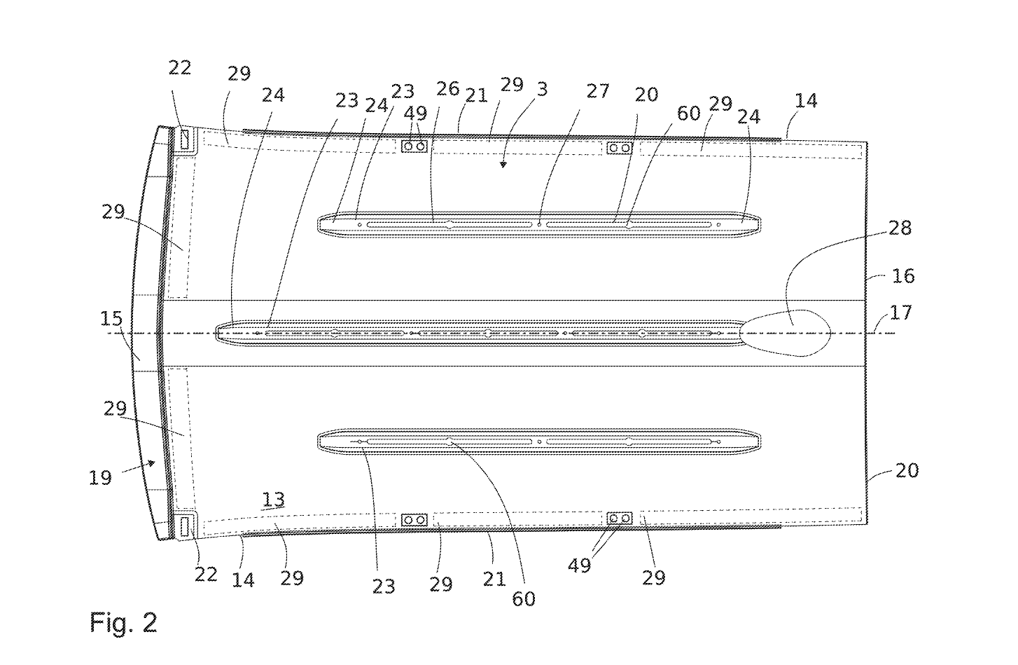

In the following, another embodiment of a bottom element 3 will be described with the aid of FIG. 31. The bottom element 3 corresponds substantially to that shown in FIG. 2.

The bottom element 3 has four lift-out brackets 80, each of which is linked at the corner regions of the bottom element 3 and can swivel about a pivot axis 81. Two lift-out brackets 80 are arranged respectively at the front boundary wall 19 and at the rear boundary wall 20, in each case in an outer side region. More or less than four lift-out brackets 80 may also be provided. The lift-out brackets may also be arranged in the region of the lengthwise edges 14 of the bottom element 3.

The lift-out brackets 80 are substantially ring-shaped. The lift-out brackets 80 may have a handle section, which simplifies the grasping of the lift-out brackets 80 by two or more fingers. The lift-out brackets 80 may be cushioned in the area of the handle section so that a user may conveniently grasp the handle section of the lift-out brackets 80 and pull on it. In FIG. 31 the lift-out brackets 80 are arranged in a position resting against the bottom element 3. In this position, the lift-out brackets are arranged inactively and space-saving on the bottom element 3.

The lift-out brackets 80 serve for the easier lifting of the bottom element 3, i.e., for removing the bottom element 3 from the roof of the motor vehicle. For this, the lift-out brackets 80 can be folded about the respective pivot axis 81 away from the bottom element 3 until they are arranged substantially perpendicular to a plane formed by the bottom element 3. In this arrangement, a user can lift the bottom element 3 and especially the roof container 1 by the lift-out brackets 80 from the motor vehicle roof. The force exerted by a user in removing the bottom element 3 from the motor vehicle roof is reduced. The handling is easier. The risk of an accidental damaging of the motor vehicle roof when removing the roof container is reduced.

In the following, another embodiment of a bottom element 3 will be explained more closely with the aid of FIG. 32 and FIG. 33. In the bottom element 3, a suction cup element 82 is integrated in at least one of the profile elements 23. The suction cup element 82 is part of the fastening unit by means of which the bottom element 3 can be mounted on the motor vehicle roof 2. In particular, the fastening unit may comprise solely suction cup elements, in particular at least one suction cup element 82. It is conceivable to combine suction cup elements 82 with other fastening elements, such as a magnetic mounting.

The major benefit of a suction cup mounting is that a magnetic holding force is unnecessary. The suction cup mounting in particular is independent of the material. In particular, the suction cup mounting with the suction cup elements 82 may be used on nonmetallic materials, such as plastics, in particular fiber-reinforced plastic materials, especially carbon fiber-reinforced plastic materials.

The suction cup element 82 in particular is situated adjacent to or at an outlet region 24 of the profile element 23. More than one suction cup element 82, such as two suction cup elements 82, may also be arranged along a profile element 23. The suction cup elements 82 may be arranged at different profile elements 23 of the bottom element 3.

The suction cup element 82 has a hollow cylindrical frame 83, which is oriented by its cylinder longitudinal axis substantially perpendicular to the motor vehicle roof 2. At an upper end of the frame, facing away from the motor vehicle roof 2, an activating lever 84 is linked to swivel about an activating axis 85. Directly connected to the activating lever 84 is a suction cup cone 86, which sticks out at the lower end face of the frame 83, situated opposite the activating axis 85.

In the arrangement shown in FIG. 33, the activating lever 84 is in the interlocking position. In this position, the suction cup cone 82 is activated such that the suction cup cone is pressed by its circular end face against the motor vehicle roof 2 with partial vacuum in the suction cup cone 86. In this arrangement, the suction cup element 82 and thus the profile element 23 and the bottom element 3 is held on the motor vehicle roof 2. For the releasing of the interlocking, the activating lever 84 is lifted counterclockwise about the activating axis 85 as in FIG. 33. In this way, the partial vacuum in the suction cup cone 86 is released and the bottom element may be lifted off from the motor vehicle roof 2.

It is also conceivable to arrange the suction cup elements 82 at other places of the bottom element 3. The arrangement or the integration in the profile elements 23 is especially space-saving and aesthetically pleasing.

The roof container 1 may be made advantageously of lightweight materials, especially lightweight metals and/or lightweight nonmetallic materials such as plastics, especially fiber-reinforced plastics and in particular carbon fiber-reinforced and/or glass fiber-reinforced plastics.

According to another sample embodiment not shown in the figures, the fastening unit may have one or more adhesive strips, which are in particular rereleasable. Such adhesive strips are known from other areas of application, especially the household. Such adhesive strips may be arranged directly between the underside of the bottom element 3 and the motor vehicle roof 2. The adhesive strips may be arranged on a broad surface and in particular along the outer contour of the motor vehicle roof on the bottom element 3. Surprisingly, it has been discovered that such adhesive strips assure an adequate fastening of the roof container 1 on the motor vehicle roof 2, especially if the roof container 1 is made of a lightweight material.

According to another sample embodiment not shown in the figures, the bottom element 3 may have a curvature which is greater than the curvature of the motor vehicle roof 2. A cavity is formed between an underside of the bottom element 3 and the motor vehicle roof 2. The curvature is oriented in particular in the transverse direction, i.e., substantially parallel to the front edge 15 and/or the rear edge 16. Because the bottom element 3 is curved more than the motor vehicle roof 2, the bottom element 3 is arranged with mechanical pretensioning on the motor vehicle roof 2. In particular, the bottom element 3 is not vaulted for the entire surface. The vaulting is provided in particular in regions. In particular, a vaulting in the areas of cross braces of the vehicle roof 2 is not needed. Such cross braces are provided beneath the outer skin of the motor vehicle roof 2 for the cross connection to the respectively oppositely situated A, B, and/or C columns of the motor vehicle.

A mechanical anchoring of the bottom element 2 at the roof railing 34 is improved. Thanks to the vaulted design, force is applied from the bottom element 3 to the motor vehicle roof 2, especially to the roof railing 34. The absorbing of axial forces, i.e., forces acting parallel to the driving direction of the motor vehicle and which are caused for example by a braking event, especially an unintentional impact, is reliably transmitted to the roof railing 34 by the roof container 1. The vaulted bottom element may have additional fastening elements. It is also conceivable that, thanks to the vaulted design, the mechanical pretensioning may serve as the sole fastening of the roof container 1 on the motor vehicle roof 2.

A further embodiment of the roof container 1 shall be explained with the aid of FIG. 34. On an underside of the bottom element 3 there is arranged a load sensor 87, which stands in signal communication with a control unit, not shown. In particular, the load sensor 87 is connected wirelessly to the control unit.

The load sensor 87 serves for detecting a cargo 88 secured in the roof container, especially on the bottom element 3. For the detecting of the cargo, the load sensor can be based on different physical measurement principles, such as a weight sensor and/or a capacitive sensor. The load sensor 87 according to the sample embodiment shown is arranged between the underside of the bottom element 3 and the top side of the motor vehicle roof 2. The load sensor can be integrated in the motor vehicle roof 2. The load sensor may also be provided on an inside of the roof container 1. For example, the load sensor 87 may be integrated in the cavity formed by a profile element 23. Several load sensors 87 may also be provided.

The load sensor 87 may be designed in particular as a pressure-sensitive film, making possible a two-dimensional, especially a full-surface, monitoring of the load in the roof container 1.

The load sensor 87 serves for detecting whether a cargo 88 is arranged in the roof container 1. In this case, the load sensor 87 can relay a signal to the control unit. In addition, interlocking elements may be provided in order to detect whether the cargo 88 is locked or secured against the bottom element 3. If unsecured cargo 88 is present in the roof container 1, the driver of the motor vehicle may receive a corresponding signal from the control unit, for example on the onboard computer. The risk of transporting unsecured cargo in the roof container is reduced. The load sensor 87 may also be used to make possible a uniform loading of the roof container 1. For this, it is advantageous to read out individually a plurality of load sensors distributed and arranged along the bottom element 3, in order to produce and analyze a load profile along the surface of the bottom element 3.

The load sensor 87 may also be used to prevent an overloading, i.e., an exceeding of a maximum cargo weight. The one or more load sensors 87 can detect a total loading and compare this to a limit value stored in the control unit. If the limit value is exceeded, a warning can be sent for example to the onboard computer of the motor vehicle.

All the electronic components of the roof container 1 may be designed for a battery power supply. In addition or alternatively to the battery, it is conceivable to provide a transmission unit, which receives signals from an external sending unit. The signals received from the external sending unit may be utilized at least partly by means of an induction device for energy transformation and energy storage, for example in a capacitor. In this way, it is possible to transmit energy by means of induction to electronic components of the roof container 1, such as the load sensors 87, and to use this energy to operate the load sensors and/or other components in the roof container 1. A separate, independent energy source for the roof container 1 is then unnecessary.

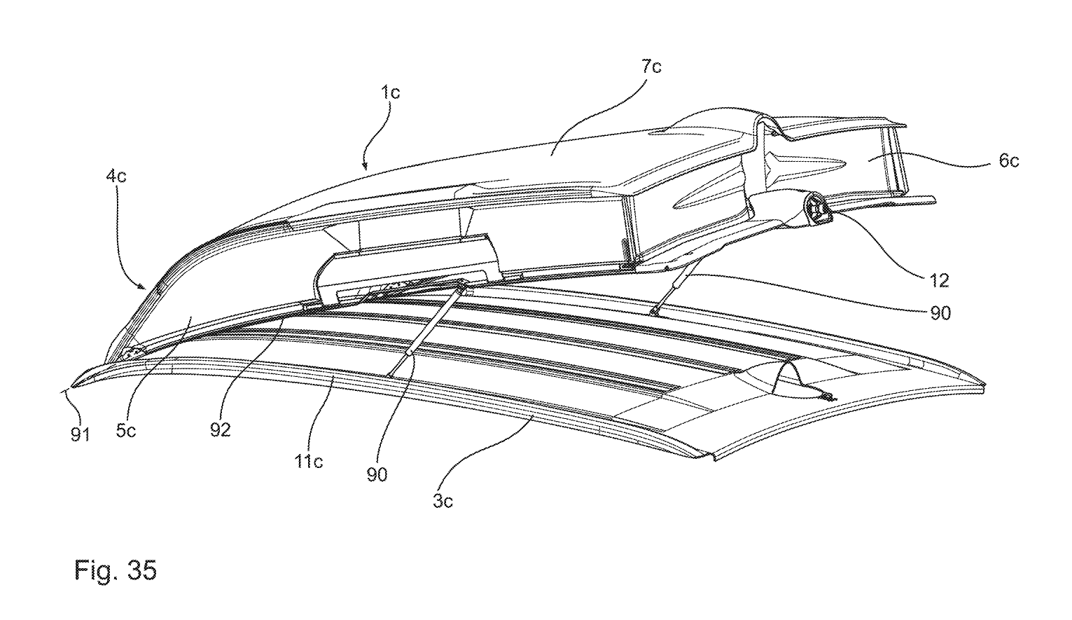

In the following, another sample embodiment of the invention will be described with reference to FIGS. 35 to 37. Structurally identical parts will be given the same reference numbers as in the previous sample embodiments, to whose description reference is hereby made. Structurally different, yet functionally identical parts will be given the same reference numbers with an added “c”.

The roof container 1c differs substantially from the roof container shown in FIGS. 1 to 4 in that a force storage element 90 is arranged at each side for the opening of the cover unit 4c with the cover wall 7c. The force storage element 90 according to the sample embodiment shown is designed as a gas pressure spring. A first end of the force storage element is arranged on the bottom element 3c and especially on an inside of the frame 11c. A second end of the force storage element 90, situated opposite the first end, is pivotlinked to a side wall 5c, especially to an underside 92 of the side wall 5c.

The force storage element 90 is designed such that a manual swiveling of the cover unit 4c with respect to the bottom element 3c about an opening pivot axis 91 is possible and in particular it is assisted. The opening pivot axis 91 is arranged substantially along the front edge 15. The force storage element 90 prevents an unwanted dropping of the roof container by the weight of the cover unit 3c.

The force storage element 90 may also be designed as a driven unit, especially in the form of an electrically driven spindle drive. Upon opening the roof container 1c, which can be manually or electrically controlled, especially radio controlled, via the lock 12, the electrically driven spindle drive is activated and the opening movement of the cover unit 4c with respect to the bottom element 3c is thereby electrically driven.

The lock 12 is arranged on the rear wall 6c. The lock 12 serves in particular for the interlocking of the roof container 1c in the closed arrangement. In the closed arrangement, the cover unit 4c is interlocked on the bottom element 3c. A swiveling about the opening pivot axis 91 is then not possible.

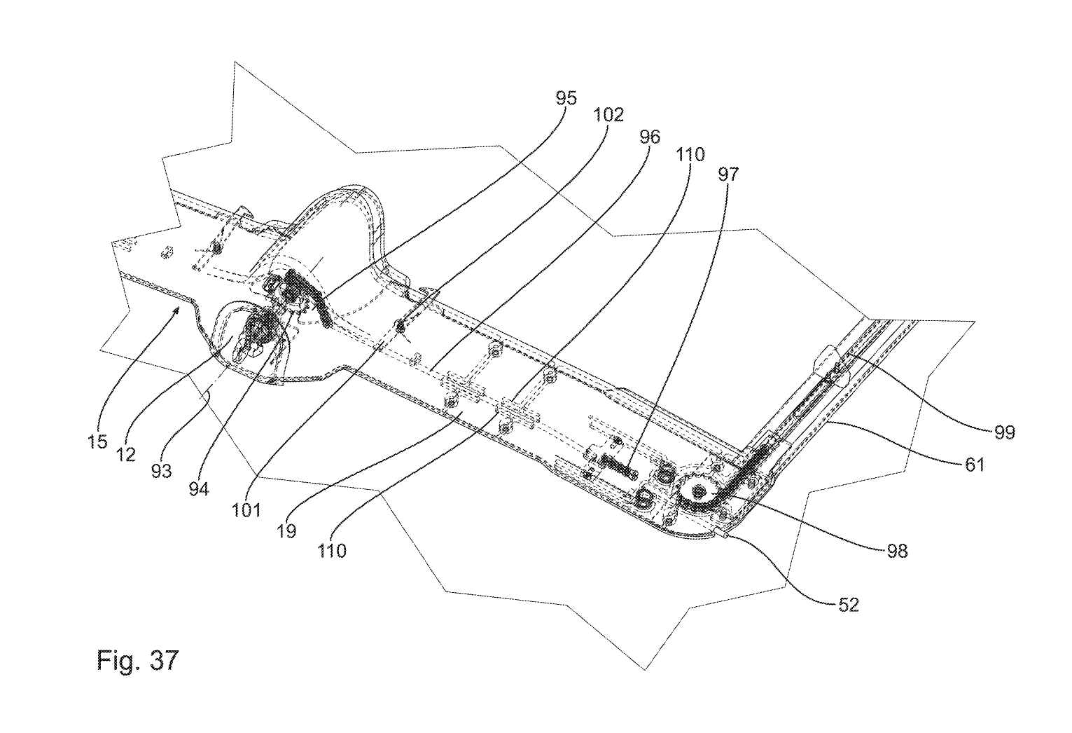

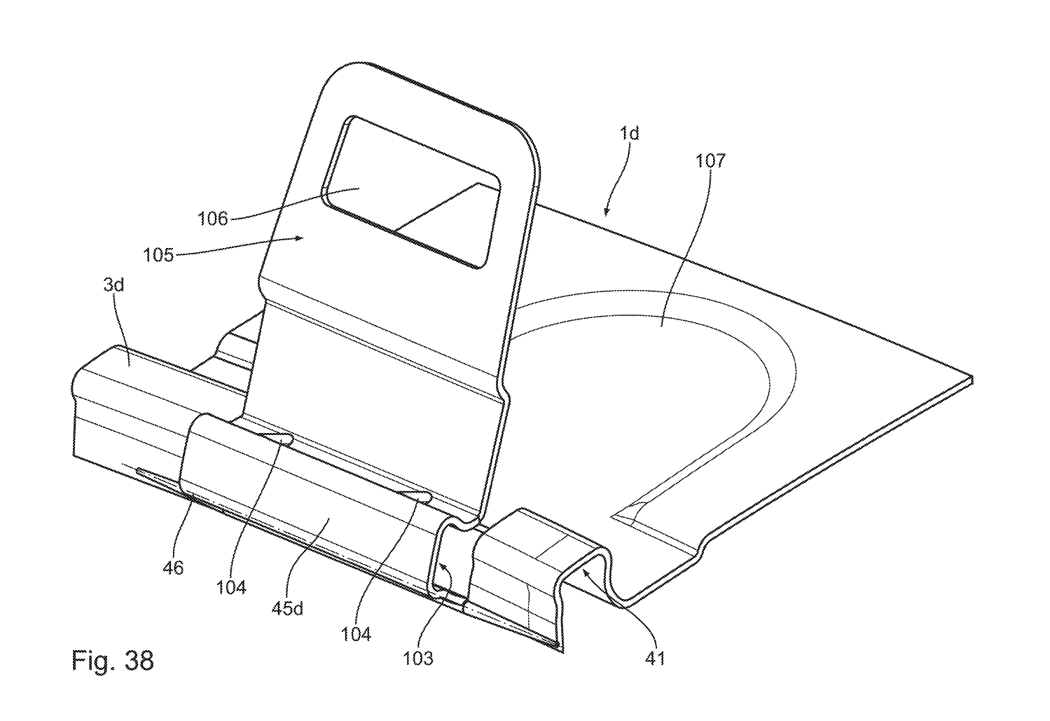

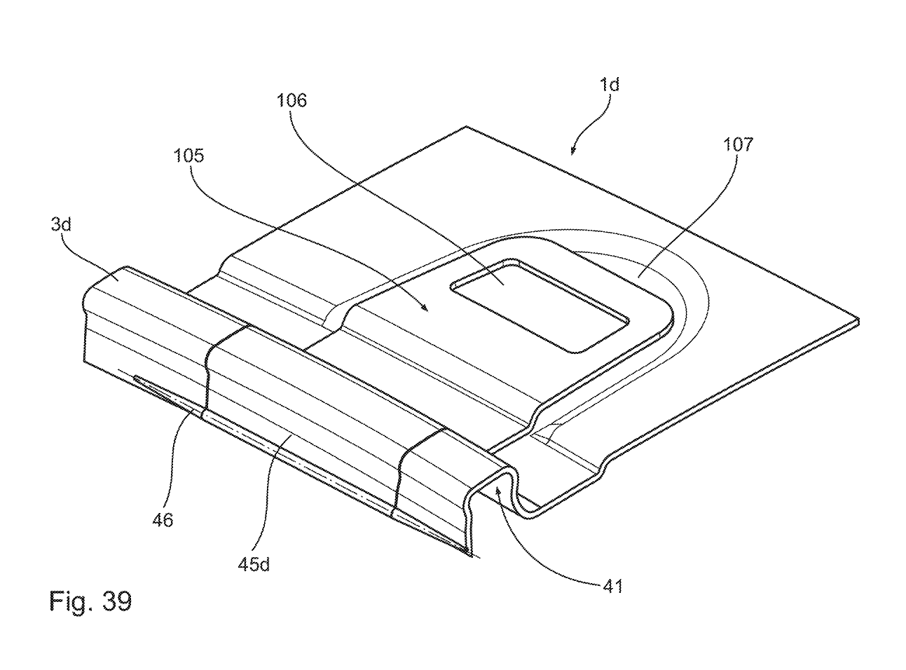

The interlocking function of the lock 12 shall be explained more closely below with the aid of FIGS. 36 and 37. Upon activating the lock, there occurs a rotary movement about a lock rotation axis 93. Concentrically to the lock rotation axis 93, a driving gear 94 is connected rotationally firmly to the lock 12. The driving gear 94 interacts with a drive chain 95, which is connected to a control rod 96. At one end situated opposite the drive chain 95, the control rod 96 is connected to a deflecting chain 97, which engages with a deflecting gear 98 for the guided deflection of the control chain 97. The deflecting gear 98 produces a 90° deflection of the deflecting chain 97. At an end situated opposite to the control rod 96, the deflecting chain 97 is connected to an interlocking rod 99. The interlocking rod 99 extends substantially along the side lengthwise elements 61 of the frame 11c. On the interlocking rod 99 is secured at least one interlocking block 100, having a bevel facing toward the deflecting chain 97. Additional interlocking blocks may be provided on the interlocking rod 99. In addition, the interlocking rod 99 may be coupled for the activating of transversely extending interlocking elements, as shown for example in FIG. 15.

The control rod 96 interacts with a spring-loaded hook element 101. The hook element 101 is spring loaded by means of a spring element, especially one in the form of a torsion spring 102, such that the hook element 101 in an unactivated state is forced into an interlocking position.

When the lock 12 is activated, the lock 12 and thus the driving gear 94 are rotated about the lock rotation axis 93. This rotary movement is transmitted by the driving gear 94 to the drive chain 95 and thus to the control rod 96. By the movement of the control rod 96, the hook element 101 is moved against the spring force of the spring element 102 out from the interlocking position, i.e., it is unlocked. The displacement of the control rod 96 is transmitted to the deflecting chain 97 and the interlocking rod 99. The displacement of the control rod 96 brings about a displacement of the interlocking rod 99 and thus of the interlocking blocks 100 into an unlocking position. In this position, the cover unit 4c is released from the bottom element 3c, i.e., it is unlocked. An opening of the roof container 1c is possible.

The locking of the roof container 1c occurs in corresponding reverse direction of activation of the lock 12 and the components coupled to it.

The control rod 96 is guided sideways along the front edge 15 by means of guide elements 110. The guide elements 110 are integrated in particular at the front boundary wall 19.

In the following, another sample embodiment of the invention will be described with reference to FIGS. 38 and 39. Structurally identical parts will be given the same reference numbers as in the previous sample embodiments, to whose description reference is hereby made. Structurally different, yet functionally identical parts will be given the same reference numbers with an added “d”.

In the embodiment, the bottom element 3d has an integrated locking lever 45d. The locking lever 45d is linked to the bottom element and able to swivel about a pivot axis 46. The bottom element has a profile geometry 41 corresponding to the outer contour of the roof railing 34. The pivot axis 46 is oriented substantially parallel to the longitudinal direction of the roof railing 34.

The locking lever 45d has an interlocking section 103 fashioned correspondingly to the profile geometry of the bottom element 3s. The interlocking section may have one or more stiffening elements 104, which serve for the stiffening of the interlocking section 103.

In the unlocked position per FIG. 38, the locking lever 45d with the interlocking section 103 is situated at a distance from the railing 34. In the unlocked position, the locking lever 45d does not engage and interlock with the roof railing 34.

The locking lever 45d furthermore has an activating section 105 with a handle hole 106. The activating section 105, especially the handle hole 106, is designed on the locking lever 45d such that, in the locked arrangement of the locking lever 45d shown in FIG. 39, the activating section 105 and especially the handle hole 106 is arranged at a distance from the bottom element 3d. For this purpose, the bottom element 3d has a trough-shaped indentation 107, in which the locking lever 45d can be inserted. In the locked arrangement of the locking lever 45d, it fits into the outer contour of the bottom element 3d. The locking lever 45d does not stand in the way of the use of the roof container 1d and especially the bottom element 3d. Their functionality is not impeded by the locking lever 45d.

For the latching of the bottom element 3d onto the motor vehicle roof, the locking lever 45d starting from the unlocked arrangement in FIG. 38 is swiveled about the pivot axis 46 until the locking lever 45d has latched by the interlocking section 103 onto the roof railing 34. Thanks to the stiffening elements 104, a tight connection, especially a positive connection, occurs between the locking lever 45d and the roof railing 34. An unlocking occurs in that on operator can reach into the recessed handle 106 of the operating section 105 and swivel the locking lever 45d about the pivot axis 46. Due to the fact that the locking lever 45d is made of a flexible material, such as plastic, and furthermore has a structural flexibility on account of the thin-wall design of the interlocking section 103, a reliable locking and repeated swiveling of the arrangement of the locking lever 45d away from and toward the roof railing 34 is assured. The stiffening elements 104 prevent an unintentional opening of the locking lever 45d.

1-15. (canceled)

16. A foldable roof container for a motor vehicle, the foldable roof container comprising:
a bottom element;
a cover unit fastened to the bottom element; and
an integrated fastening unit for the direct, releasable fastening of the roof container on the motor vehicle.

17. The roof container as claimed in claim 16, wherein the bottom element is designed as a single piece.

18. The roof container as claimed in claim 17, wherein the bottom element comprises a bottom wall and boundary walls formed on it.

19. The roof container as claimed in claim 17, wherein the boundary walls comprise a front boundary wall, a rear boundary wall, and two side boundary walls respectively arranged in between.

20. The roof container as claimed in claim 16, comprising at least one profile element in the bottom element.

21. The roof container as claimed in claim 16, comprising a protective coating on an exterior underside of the bottom element.

22. The roof container as claimed in claim 16, wherein the fastening unit comprises at least one magnetic element.

23. The roof container as claimed in claim 22, wherein the magnetic element of the fastening unit is integrated in at least one of the group comprising a side boundary wall, a bottom wall, a front boundary wall, and a rear boundary wall.

24. The roof container as claimed in claim 16, wherein the fastening unit comprises shaped elements, which are arranged on the bottom element.

25. The roof container as claimed in claim 24, wherein the shaped elements of the fastening unit are provided on the side boundary walls.

26. The roof container as claimed in claim 24, wherein the shaped elements are integrated in the side boundary walls.

27. The roof container as claimed in claim 26, wherein the shaped elements are designed as a clamping lip situated at an inclination by an angle of inclination with respect to the bottom wall.

28. The roof container as claimed in claim 26, wherein the shaped elements have a profile geometry at least partially enclosing a roof railing.

29. The roof container as claimed in claim 28, wherein the shaped elements have a profile geometry enclosing a roof railing entirely.

30. The roof container as claimed in claim 26, wherein at least one shaped element is integrated on the bottom wall for at least partial enclosing of an antenna molding situated on the roof.

31. The roof container as claimed in claim 16, wherein the fastening unit comprises a hook element for hooking in a gap of the bodywork of the motor vehicle.

32. The roof container as claimed in claim 16, wherein the fastening unit comprises a clamping element for clamping in a gap of the bodywork of the motor vehicle.

33. The roof container as claimed in claim 32, wherein the clamping element of the fastening unit is configured as a clamping strap.

34. The roof container as claimed in claim 16, wherein the fastening unit comprises at least one locking lever for resting against the roof railing in an interlocked manner.

35. The roof container as claimed in claim 16, comprising a protective fastening for protection against accidental releasing of the roof container.

36. The roof container as claimed in claim 35, wherein the protective fastening can be activated only in the opened state of the roof container.

37. The roof container as claimed in claim 35, wherein the protective fastening is arranged inside the roof container.

38. The roof container as claimed in claim 35, wherein the protective fastening comprises at least one laterally movable interlocking element.

39. The roof container as claimed in claim 35, wherein the protective fastening comprises at least one fastening element for fastening to a fastening point integrated in the roof.

40. The roof container as claimed in claim 16, comprising at least one of the group comprising a control unit connectable to the motor vehicle for independent driving of the motor vehicle and a display element for displaying of contents.

41. The roof container as claimed in claim 40, wherein the display element is a movable display element for displaying digital contents.

42. A foldable roof container for a motor vehicle, the foldable roof container comprising:
a bottom element;
a cover unit fastened to the bottom element; and
at least one integrated anchoring unit for the anchoring of an object in the roof container.

43. The roof container as claimed in claim 42, wherein the anchoring unit comprises an anchoring element at which the object is releasably anchorable to a corresponding mating anchoring element.
